(19) United States
(12) Patent Application Publication
(10) Pub. No.: US 2023/0284801 A1
(43) Pub. Date: Sep. 14, 2023

(54) Medical Heater Blanket with Temperature Sensor

(71) Applicant: Gentherm Medical LLC, Cincinnati, OH (US)

(72) Inventors: Florian Sandmair, Ried (DE); Manfred Gies, Odelzhausen (DE); Timothy E. Hughes, South Lyon, MI (US); James Frederick Krier, Grosse Pointe Woods, MI (US)

(21) Appl. No.: 18/200,754

(22) Filed: May 23, 2023

Related U.S. Application Data
(63) Continuation of application No. PCT/US2021/060676, filed on Nov. 24, 2021.
Application No. PCT/US2021/060676 is a continuation of application No. PCT/US2021/060677, filed on Nov. 24, 2021.
Application No. PCT/US2021/060677 is a continuation of application No. PCT/US2021/060681, filed on Nov. 24, 2021.
(60) Provisional application No. 63/117,499, filed on Nov. 24, 2020.
(60) Provisional application No. 63/117,508, filed on Nov. 24, 2020.
(60) Provisional application No. 63/233,991, filed on Aug. 17, 2021.
(60) Provisional application No. 63/117,501, filed on Nov. 24, 2020.

(51) Int. Cl. A47G 9/02; H05B 3/34

(52) U.S. Cl. CPC A47G 9/0215; H05B 3/342

(57) ABSTRACT

A heating blanket that includes: a first heating segment comprising a first heating section and a first sensing section, the first heating section comprises one or more heating elements and the first sensing section comprises one or more sensing elements; a second heating segment comprising a second heating section, the second heating section comprises one or more heating elements; the first sensing section overlaps the second heating section and the one or more sensing elements in the first sensing section monitor or determine an amount of heat generated by the one or more heating elements in the second heating section.

### CROSS-REFERENCE TO RELATED APPLICATIONS

This application is a continuation of PCT/US2021/060676 filed on Nov. 24, 2021, which claims priority to U.S. 63/117,499 filed on Nov. 24, 2020; a continuation of PCT/US2021/060677 filed on Nov. 24, 2021, which claims priority to U.S. 63/117,508 filed on Nov. 24, 2020 and U.S. 63/233,991 filed on Aug. 17, 2021; and a continuation of PCT/US2021/060681 filed on Nov. 24, 2021, which claims priority to U.S. 63/117,501 filed on Nov. 24, 2020; all of which are hereby incorporated by reference herein for all purposes.

### FIELD

These teachings relate to a heating system, a heating blanket and/or to a method of making a heating blanket.

### BACKGROUND

Heating blankets may be used in medical and/or non-medical applications to raise and/or maintain the body temperature of a patient or user. Exemplary heating blankets and/or heating systems are disclosed in US 2019/0365113A1, in one or more of the family applications of US 2019/0365113A1, and US 2006/052852A1, all of which are incorporated by reference herein for all purposes. It would be desirable to improve the current state of the art by having an improved heating system, a heating blanket and/or to a method of making a heating blanket that includes one or more integrated temperature sensors; and/or to have a heating blanket comprising two or more heating segments and a single connector configured for power supply and/or temperature sensing; and/or to have a heating system, blanket, and/or a method to reduce hot spots. It may be desirable to improve the current state of the art by having a heating system, blanket, and/or a method of obtaining a generally uniform temperature across a heating area of the heating system or blanket. It may be desirable to improve the current state of the art by having a device and method of adding or removing insulation from certain areas of the heating system or blanket to tune or adjust the heat output of the system or blanket to achieve a generally uniform temperature across a heating area of the heating system or blanket. It may be desirable to have a heating blanket having a heating layer made of one or more heating segments. It may be desirable to have a heating blanket having a heating layer made of one or more heating segments with added insulating masking to certain areas of the heating system or blanket to locally tune or adjust the heat output of the system or blanket to achieve a generally uniform temperature across a heating area of the heating system or blanket.

### SUMMARY

These teachings provide a heating system and a heating blanket. These teachings provide a method of making a heating blanket. The heating blanket according to these teachings includes one or more integrated temperature sensors.

These teachings provide a heating system and/or a method of making a heating blanket. The teachings provide a method of reducing or mitigating hot spots in a heating blanket or system. These teachings provide a heating system and/or a method of obtaining a generally uniform temperature across the heating area of the heating system. These teachings provide a heating system and/or a method of applying an insulating material in one or more regions of a heating layer or heating segment of a heating blanket or system that produce warm or hot spots, compared to other regions of the heating layer that produce a lower temperature. By varying the amount and/or the type of insulation provided on certain regions of the heating layer (i.e., by adding insulation, more insulation, or a different type of insulation in regions of the heating layer that measure warmer or hotter than other regions of the heating layer that measure cooler), hot spots can be reduced or eliminated. Accordingly, these teachings can be used to improve user comfort by reducing or eliminating hot spots in certain areas of the heating system or blanket that may cause burns or patient discomfort. These teachings can be used to improve user comfort by obtaining a generally uniform temperature across the heating area of the heating system. These teachings can be applied to heating systems that are required to comply with certain specifications, where allowable temperature variations across a heating area is quite small. For example, IEC 80601-2-35, specifies the requirements for basic safety and essential performance of heating devices using blankets, pads or mattresses and intended for heating in medical use allows minimal temperature variation (as low as +/−1 deg C.).

These teachings provide a device and method of adding or removing insulation from certain areas of the heating system to locally tune or adjust the heat output of the system to achieve a generally uniform temperature across a heating area of the heating system. That is, insulation having various insulating properties may be added locally to certain areas of the heating blanket, heating segments, or system so that the heat output in that local region is reduced. In some configurations, insulation may be locally removed, eliminated, or reduced from cold spots, so that the cold spots actually provide a greater heat output.

These teachings can be applied to the teachings disclosed in one or more of the following applications: U.S. Pat. No. 63,117,499 filed on Nov. 24, 2020; U.S. 63/117,508 filed on Nov. 24, 2020; U.S. 63/233,991 filed on Aug. 17, 2021; and U.S. 63/117,501 filed on Nov. 24, 2020. The aforementioned applications are all incorporated by reference herein for all purposes. Any PCT application filed by Applicant or at the direction of Applicant that claim priority to any of the aforementioned US priority applications are also incorporated by reference herein for all purposes. One or more of any of the teachings herein can be applied or combined with one or more of the teachings in the aforementioned applications. Advantageously, by applying one or more of the teachings herein one or more of the teachings in the aforementioned applications, a heating system and/or blanket can be obtained with reduced or no hot spots and/or a generally uniform temperature across the heating area of the heating system.

These teachings provide a heating system, a heating blanket, and/or to a method of making a heating blanket. These teachings provide a heating blanket comprising two or more heating segments and a single connector configured for power supply and/or temperature sensing. Advantageously, a custom sized heating blanket can be provided by joining together any number of heating segments and then controlling the same using a single connector. The connector may be configured to provide power to the two or more heating segments and/or temperature sensing in local areas on the two or more heating segments.

These teachings provide a method of making a heating blanket comprising: performing a material removal operation on a first electrically conductive foil, wherein portions of the first electrically conducive foil that remain after the material removal operation form one or more first heating elements located on a first base layer of a first heating segment; performing a material removal operation on a second electrically conductive foil, wherein portions of the second electrically conducive foil that remain after the material removal operation form one or more second heating elements on a second base layer of a second heating segment; and electrically and physically connecting together the first heating segment and the second heating segment to form a heating layer of the heating blanket.

The material removal operation may be a cutting or milling operation and is not an etching operation. The method may comprise bonding an insulating layer to the one or more first heating elements and/or to the one or more second heating elements to reduce or eliminate hot spots on the heating layer. The insulating layer may comprise a flocking material that is bonded directly to the one or more first heating elements and/or to the one or more second heating elements. After performing the material removal operation on the first heating segment and/or on the second heating segment, portions of the first electrically conductive foil that remain form one or more first sensing elements, and/or portions of the second electrically conducive foil that remain form one or more second sensing elements. The one or more first sensing elements may be configured to monitor or detect heat generated by the one or more second heating elements. The one or more first sensing elements may be configured to monitor or detect heat generated by the one or more first heating elements. The one or more first heating elements may be arranged in a first pattern, and the one or more second heating elements are arranged in a second pattern, wherein the two patterns are different. The one or more first heating elements may be arranged in a first pattern, and the one or more second heating elements are arranged in a second pattern, wherein the two patterns are the same. The method may comprise connecting together the first heating segment and the second heating with a conductor strip. The conductor strip may be a separate element from the first heating segment and the second heating segment. The insulating layer may include a first portion and a second portion, wherein the first portion and the second portion have different thermal properties. The insulating layer may comprise a first portion and a second portion, wherein the first portion of the insulating layer has a thickness that is greater than the second portion of the insulating layer. Before or after electrically and physically connecting together the first heating segment and the second heating segment, the method may comprise determining a heat output of the heating layer and identifying any hot spots; and applying an insulating layer to the hot spots to locally reduce or eliminate the hot spots. The applying step comprises applying flocking to the hot spots.

The heating blanket may include a first heating segment comprising a first heating conductor; a second heating segment that is separate from the first heating segment, the second heating segment comprising a second heating conductor; and a single connector configured to electrically join together the first heating segment and the second heating segment, the single connector is configured to supply power to the first heating conductor and to the second heating conductor to generate heat.

The heating blanket may include a separate sensing conductor that is separate from the first heating segment and/or the second heating segment, the separate sensing conductor is configured to monitor or determine an amount of the heat generated by the first heating conductor and/or the second heating conductor, the separate sensing conductor is electrically connected to the single connector. The first heating segment may include a first sensing conductor that is configured to monitor or determine an amount of the heat generated by the first heating conductor and/or the second heating conductor, the first sensing conductor is electrically connected to the single connector. The first sensing conductor is on the first finger that projects or cantilevers from an edge of the first heating segment and overlaps a portion of the second heating segment. The first heating segment may include a first sensing conductor that is configured to monitor or determine an amount of the heat generated by the first heating conductor and/or the second heating conductor, the first sensing conductor is electrically connected to the single connector. The second heating segment may include a second sensing conductor that is configured to monitor or determine an amount of the heat generated by the first heating conductor and/or the second heating conductor, the second sensing conductor is electrically connected to the single connector. The second sensing conductor may be on a finger that projects or cantilevers from an edge of the second heating segment and overlaps a portion of the first heating segment. The first heating conductor may have a first heating terminal, and the second heating conductor has a second heating terminal, the first heating terminal and the second heating terminal are located proximate to each other and disposed at a common edge of the heating blanket for electrically connecting to the single connector. The first heating segment may include a first sensor conductor connected to one or more sensing elements configured to monitor or determine an amount of the heat generated by the first heating conductor and/or the second heating conductor, the first sensor conductor has a first sensor terminal, the first sensor terminal is located proximate to the first heating terminal and the second heating terminal for electrically connecting to the single connector. The heating blanket may have a third heating conductor and a fourth heating conductor, the third heating conductor has a third heating terminal, and the fourth heating conductor has a fourth heating terminal, the third heating terminal and the fourth heating terminal are located proximate to each other and to the first heating terminal and the second heating terminal. The heating blanket may include a second sensor conductor connected to one or more sensing elements configured to monitor or determine an amount of the heat generated by the first heating conductor and/or the second heating conductor, the second sensor conductor has a second sensor terminal, the second sensor terminal is located proximate to the first heating terminal, the second heating terminal, the third heating terminal, the fourth heating terminal, and the first sensor terminal for electrically connecting to the single connector. The single connector may be connected to the first heating segment at a first connection and to the second heating segment at a second connection. The first connection and/or the second connection may include a heat stake. The single connector may include a top cover portion and a bottom cover portion, wherein the top cover portion is located on a top side of the heating blanket and the bottom cover portion is located on a bottom side of the heating blanket. The first heating segment may include a heating layer comprising an electrically conductive foil layer disposed on an electrically insulative base layer, wherein the method comprises performing a material removal operation to remove a portion of the electrically conductive foil, and portions of the electrically conducive foil that remain on the base layer are the first heating conductor.

### BRIEF DESCRIPTION OF THE DRAWINGS

FIG. 1 illustrates a heating system that includes a heating blanket.

FIG. 2 is a partially exploded view of a heating blanket.

FIG. 3A is a front view of a heating segment of a heating layer of the heating blanket.

FIG. 3B is a side view of FIG. 3A.

FIG. 4A is a side view of FIG. 3A.

FIG. 4B is a side view of FIG. 3A in a folded configuration.

FIG. 5 is a side view of two heating segments each in the folded configuration of FIG. 4B that are joined together.

FIG. 6 is a front view of multiple heating segments of the heating layer of the heating blanket.

FIG. 7A is a side view of two heating segments of FIG. 3A.

FIG. 7B is a side view of the two heating segments of FIG. 7A joined together.

FIG. 8 is a front view of multiple heating segments of the heating layer of the heating blanket.

FIG. 9 is a top perspective view of plural heating segments of the heating layer of the heating blanket.

FIG. 10 is a top perspective view of the plural heating segments of FIG. 9 joined together.

FIG. 11 is a front view of the heating layer of the heating blanket.

FIG. 12 is a front view of the heating layer of the heating blanket.

FIG. 13 is a perspective view of the heating layer of the heating blanket.

FIG. 14 an exploded view of the heating blanket.

FIG. 15 is a front view of the heating blanket.

FIG. 16 an exploded view of the heating blanket.

FIG. 17 is an exploded view of a heating blanket.

FIG. 18 is a front view of a heating layer.

FIG. 19 illustrates an insulating layer.

FIG. 20 illustrates an insulating layer and a heating layer.

FIG. 21 illustrates an insulating layer and a heating layer.

FIG. 22 illustrates an insulating layer and a heating layer.

FIG. 23 illustrates an insulating layer and a heating layer.

FIG. 24 illustrates an insulating layer and a heating layer.

FIGS. 25A-25D each illustrate an insulating layer and a heating layer.

FIG. 26A is a cross section of the heating blanket.

FIG. 26B is a cross section of the heating blanket.

FIG. 26C is a cross section of the heating blanket.

FIG. 27 is a top view of the heating blanket.

FIG. 28 is a front view of a heating layer having two heating segments.

FIG. 29 is a front view of a heating layer having one heating segment.

FIG. 30 is a detailed view of a portion of FIG. 28 in the dashed box.

FIG. 31 is a front view of FIG. 28 after a processing operation.

FIG. 32 is a front view of FIG. 28 after a processing operation.

FIG. 33 shows two heating segments being joined together with two other heating segments to form a heating layer of the heating blanket.

FIG. 34 shows a connector being installed on the heating layer.

FIG. 35 is a front view of two heating segments forming the heating layer of the heating blanket.

FIG. 36 is a partial perspective view of two heating segments forming the heating layer of the heating blanket.

FIG. 37A is a front view of two heating segments of the heating layer.

FIG. 37B is a detailed view of a single connector connecting the two heating segments of FIG. 37A.

FIGS. 38-40 illustrate a connector and housing attached to the heating layer.

FIG. 41 illustrates a part of the housing and the printed circuit board of the connector.

FIG. 42 is a perspective view of the connector attached to the heating layer.

FIG. 43 is a close-up view of a portion of FIG. 42.

FIG. 44 is an assembled view of the single connector, shown in transparent, connected to the two heating segments of the heating layer.

### DETAILED DESCRIPTION

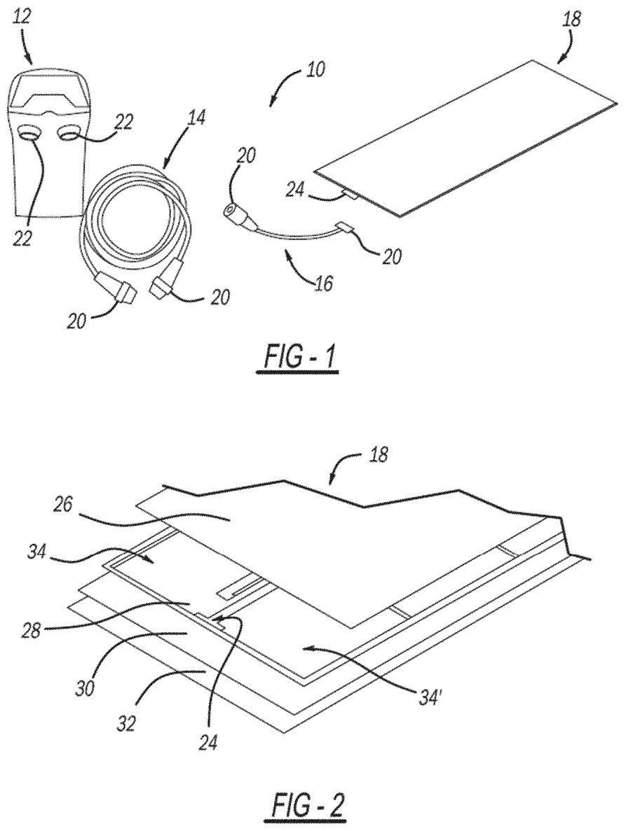

FIG. 1 illustrates a heating system 10. The heating system 10 may comprise a controller 12, one or more cables (for example, a first cable 14 and a second cable 16), and a heating blanket 18.

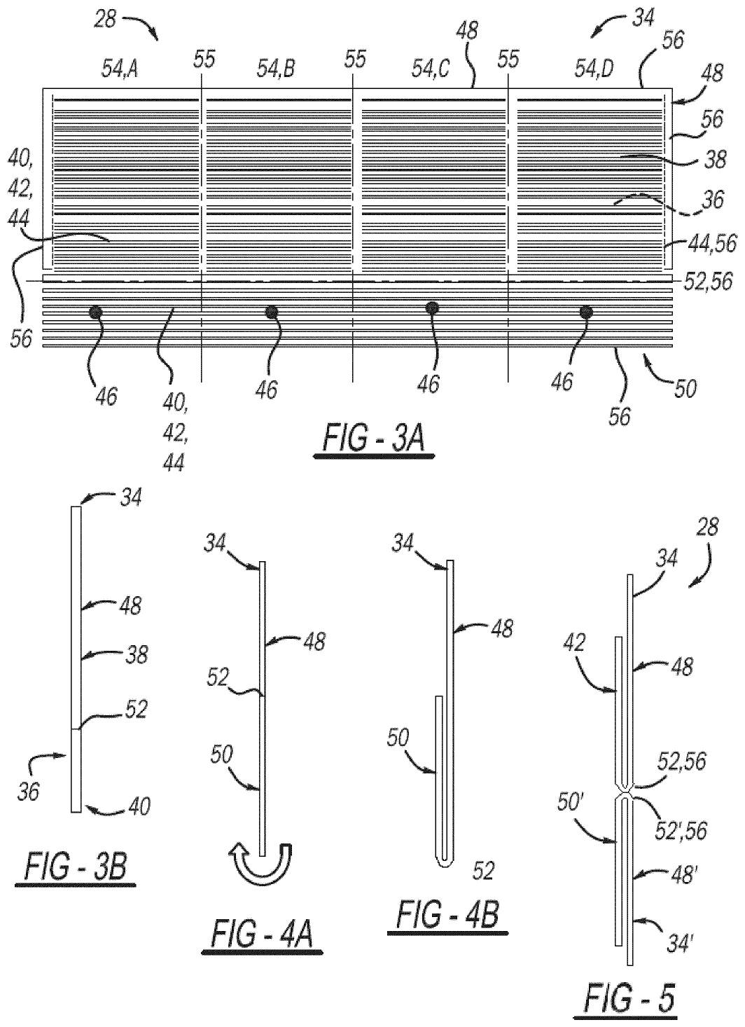

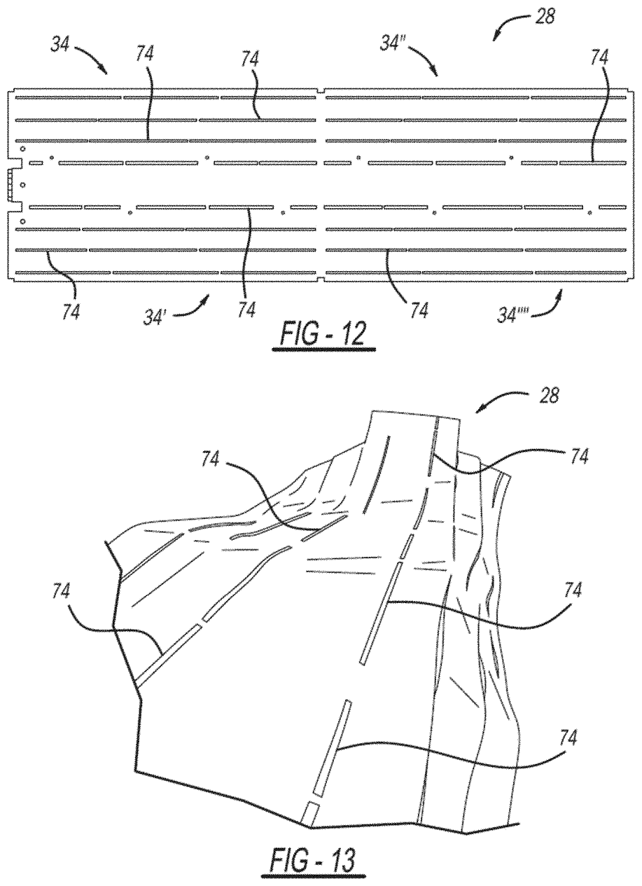

The heating system 10 and/or the heating blanket 18 according to these teachings may be or may include any of the elements, features, description, and/or construction disclosed herein. In other words, the construction, layers, and/or elements of the blanket 18 are found throughout this disclosure and may be combined, separated, omitted, duplicated, etc. to construct one or more embodiments of the system 10 and/or blanket 18. A non-limiting meaning or example of this is that the slits 74 shown and described in FIGS. 12 and 13 may be incorporated into the heating layer 28 illustrated and described in FIG. 10 or FIG. 3A.

These teachings can be applied to the teachings disclosed in one or more of the following applications: U.S. Pat. No. 63,117,499 filed on Nov. 24, 2020; U.S. 63/117,508 filed on Nov. 24, 2020; U.S. 63/233,991 filed on Aug. 17, 2021; and U.S. 63/117,501 filed on Nov. 24, 2020. The aforementioned applications are all incorporated by reference herein for all purposes. Any PCT application filed by Applicant or at the direction of Applicant that claim priority to any of the aforementioned US priority applications are also incorporated by reference herein for all purposes.

The controller 12 may be programmed, configured, or enabled to monitor and/or control the heating system 10, the heating blanket 18, one or more layers or elements of the heating blanket 18, or a combination thereof. The controller 12 may be programmed, configured, or enabled to supply the heating blanket 18 and/or one or more layers or elements of the heating blanket 18 with electrical power so that the heating blanket 18 and/or one or more layers or element of the heating blanket 18 can generate heat. The controller 12 may include one or more power sources for supplying the electrical power to the heating blanket 18 or to one or more layers or elements of the heating blanket 18. The power source may include one or more batteries, solar panels, generators, or other power generating and/or storage means. Additionally, or alternatively, the controller 12 may be connected to a power source (i.e., a wall outlet, a generator, a battery, etc.) that supplies the electrical power to the controller 12 and then to the heating blanket 18 or to one or more layers or elements of the heating blanket 18.

The one or more cables 14, 16 may be configured or enabled to transfer or conduct electrical power from and/or between the controller 12 and/or a power source to the heating blanket 18 and/or one or more elements or layers of the heating blanket 18, like the connector 24. The first cable 14 and/or the second cable 16 may be configured or enabled to transfer or conduct communication signals from and/or between the controller 12 and the heating blanket 18 or one or more layers or elements of the heating blanket 18 so that the controller 12, one or more other controllers, users, or systems can monitor and/or control operation of the heating blanket 18. In other words, based on one or more signals or commands communicated between the controller 12 and the heating blanket 18 (or one or more layers or elements of the blanket 18), the controller 12, a user, or other system may function to increase, decrease, or maintain an electrical power supply to the heating blanket 18 (or to one or more layers or elements of the heating blanket 18), may turn ON or turn OFF an electrical power supply to the heating blanket 18, may alert a user of a fault condition (e.g., too much heat, too little heat, etc.), or a combination thereof.

The first cable 14 and the second cable 16 may be integrated into a single cable for connecting the blanket 18 and the controller 12. The first and second cables 14, 16 may be divided or separated into additional sub-cables for connecting the blanket 18 and the controller 12. One or both of the cables 14, 16 may have one or more connectors or plugs 20 for connecting the cables together and/or for connecting to one or more ports, plugs, or connectors 22 on the controller 12 and/or to one or more ports, plugs, or connectors 24 on the heating blanket 18, heating layer 28, or other layers of the blanket 18.

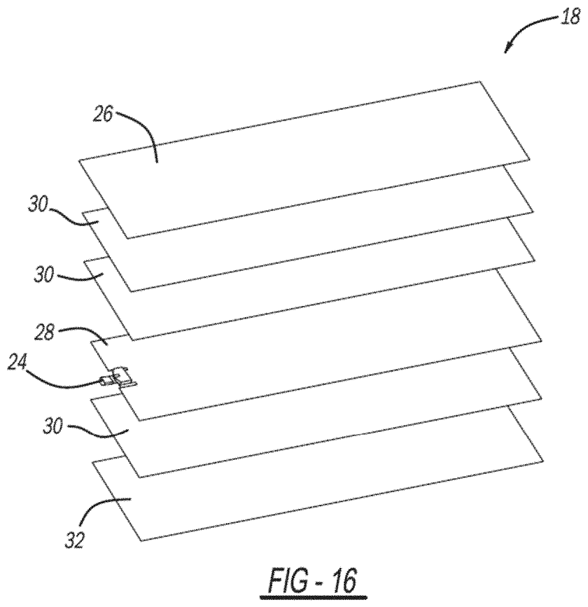

FIG. 2 illustrates the heating blanket 18. The heating blanket 18 may comprise one or more layers or sheets. The one or more layers or sheets may comprise: one or more top or first cover layers 26, one or more heating layers 28, one or more insulating layers 30, one or more bottom or second cover layer 32, or a combination thereof. Another exemplary heating blanket 18 is illustrated and described below in FIG. 16. Remarks made with regard to the blanket 18 in FIG. 2 may apply to the blanket 18 in FIG. 16 and vice versa.

The top or first cover layer 26 may be arranged on top of the heating layer 28, which may be arranged on top of the insulating layer 30, which may be arranged on top of the bottom or second cover layer 32. However, it is understood that any of these layers may be arranged in any order. For example, the heating layer 28 may be arranged below the insulating layer 30. Additionally, or alternatively, one or more of these layers may be combined into a single layer. For example, the heating layer 28 and the insulating layer 30 may be combined into a single layer (by attaching the layers together or forming them from an integral layer, for example). Additionally, or alternately, one or more of the blanket layers may be duplicated. For example, another one or more insulating layers 30 may be provided below or above the heating layer 28 and/or one or more additional heating layers 28 may be provided above or below one or more insulating layers 30. In some configurations, one or more of the layers may be joined together via one or more fasteners or may even be formed from an integral layer. The one or more fasteners may be one or more pins, buttons, clasps, welds, stiches, hook and loop fasteners, adhesives, pastes, screws, zippers, tape, double sided tape, magnets, snaps, heat stakes, etc.

In some configurations, the first and second cover layers 26, 32 may be formed from a single cover layer. For example, if constructed as a single cover layer, it can be folded over itself to cover, sandwich, and/or envelope the one or more other middle layers of the blanket 18 (e.g., one or more insulating layers 30, heating layers 28, etc.) therewithin or therebetween.

In some configurators, the first and second cover layers 26, 32 may be formed from a single cover layer or joined together to function or act like a duvet or pillowcase with one or two or three open ends. If there are two open ends, they may oppose one another, or adjoin one another. The one or more middle layers of the blanket 18 (e.g., one or more insulating layers 30, heating layers 28, etc.) may be inserted or slid into the duvet or pillowcase structure through one or more of the open ends. The one or more open ends may then be closed via one or more of any of the fasteners disclosed herein. Alternatively, one or both of the open ends may remain open. This may enable or provide for the middle layers of the blanket to be removed from within the cover for service, maintenance, and/or replacement of one or more of the layers, washing or sterilizing of the cover, or both. Alternatively, the one or more fasteners used to close the one or more open ends may be opened and closed (e.g., via snaps, buttons, hook and loop fasteners, zippers, etc.) to access and/or remove/install the middle layers. One or more of any of the middle layers of the blanket 18 may eliminated or omitted or duplicated.

In some configurations, the top or cover layer 26 may be the same as the bottom cover layer 32 (i.e., same, or similar material, structure, composition, size, etc.). In other configurations, the two cover layers 26, 32 may be different (i.e., different material, structure, composition, size, etc.) This means, one of the cover layers 26, 32 may be made from a different material, may include additional or different insulating or heat deflecting/reflecting properties, etc. In some configurations, the top layer 26 should always face up or away from the patient, and the bottom layer 32 should always face down or towards a patient or bed, or vice versa.

One or both of the cover layers 26, 32 may be made from suitable material that allows heat generated by the heating layer 28 to pass through or be conducted from the heating layer 28 to warm a patient or object near or in contact with one or more layers of the blanket 18 or proximate or adjacent to one or more layers of the blanket 18. The cover layer 26, 32 material may be made of a suitable material that resists liquid (i.e., blood, disinfectants, water, cleaners, chemicals, etc.) absorption and/or penetration. This may advantageously protect the inside layers and elements of the heating blanket 18 from damage from liquid penetration. For example, one or both of the cover layers 26, 32 may be made of one or more materials that include: a nonwoven fabric, sheet, or material; a spunbond or spunlaid fabric, sheet, or material; a polypropylene fabric, sheet, or material; an LDPE film or coating applied onto one or both layers; or a combination thereof. Other materials that meet medical use specification requirements may be utilized, including any of the materials disclosed herein for any of the other blanket layers. In some configurations, one or both of the cover layers 26, 32 may be made of a suitable material that can be washed, wiped clean, autoclaved, and/or disinfected so that the blanket 18, one or both of the cover layers 26, 32 can be reused.

The blanket 18 may include one or more insulating layers 30. The insulating layer 30 may be made from a suitable material that functions to retain heat generated by the heating layer 28, and/or direct or re-directed heat generated by one or more of the heating layers 28 to radiate in a particular direction, for example, in a direction of a user or patient as opposed to away from the user or patient, or vice versa. The insulating layer 30 may function to direct or distribute heat generated by the heating layer 28 at least partially across an entire surface of the heating blanket 18 to reduce, minimize, or eliminate any isolated hot and/or cold spots. The insulating layer 30 may function to direct or distribute heat generated by the heating layer 28 to certain areas or regions of the blanket 18, and prevent the heat generated by the heating layer 28 to be directed or distributed to other layers of the blanket 18. The insulating layer 30 may function to direct or distribute the heat generated by the heating layer 28 so that certain layers of the heating blanket 18 are warmer than others. This may be advantageous to provide the blanket 18 with the ability to have isolated warmer sections and/or cooler sections.

For example, the insulating layer 30 may be made of one or more materials that include a fleece material. Other materials that meet medical use specification requirements may be utilized, including any of the materials disclosed herein for any of the other blanket layers. The insulating layer 30 may be attached to any of the layers of the heating blanket. The insulating layer 30 may be free from direct attachment to any of the layers of the heating blanket. For example, the one or more insulating layer 30 may be attached to one or more heating layers 28, one or more other insulating layers 30, one or both of the cover layers 26, 32, or a combination thereof via one or more of any of the fasteners disclosed herein (i.e., pins, buttons, clasps, welds, stiches, hook and loop fasteners, adhesives, pastes, screws, zippers, tape, etc.)

The heating blanket 18 may include one or more heating layers 28. The heating layer 28 and/or elements of the heating layer 28 may be configured or enabled to generate heat in response to a supply of electrical energy. The heating layer 28 may generate heat by converting electrical energy supplied by the controller 12 and/or one or more power supplies or power sources into heat energy. The one or more power supplies or sources may be one or more batteries, wall outlets, AC power, DC power, solar panels, generators, or a combination thereof. The blanket 18 and/or the heating layer 28 may include one or more connectors or plugs 24 for communicating with the controller 12 and/or power supply (FIG. 1) via the one or more cables 14, 16. The heating layer 28 may comprise one or more heating segments 34, 34′.

FIGS. 3A and 3B illustrate a heating layer 28. The heating layer 28 may comprise one or more heating segments 34. One heating segment 34 is illustrated in FIG. 3A. A heating segment 34 may be a layer of the heating layer 28 and/or of the blanket 18 that includes one or more sub layers. The one or more sub layers of the heating layer 28 may include one or more carrier or base layers 36 and/or one or more foil layers 38. In some configurations, the carrier or base layer 36 may be located below the foil layer 38 or above the foil layer 38. In some configurations, the foil layer 38 may be located above and below the carrier layer 36 such that the carrier layer 36 is sandwiched between the foil layers 38. In some configurations, the base layer 36 and the foil layer 38 may be a single, integrated layer. In other configurations, the foil layer 38 may be separate from the base layer 36 but subsequently arranged, supported, attached, secured, or connected to the base layer 36.

The base layer 36 may function to stabilize or provide a support structure or carrier for the foil layer 38 or other elements or layers of the heating layer 28. The base layer 36 may be made of a suitable material, such as polyurethane, polypropylene, polymethylene, polyethylene terephthalate (PET), Polyimide (PI), the like, or a combination thereof. The base layer 36 may be electrically conductive or electrically non-conductive. The base layer 36 may be an insulator. The base layer 36 may be more rigid or stiff than the foil layer 38, or vice versa. The base layer 36 may be a

The foil layer 38 may comprise a suitable electrically conductive material, such as metal, copper, aluminum, nickel, copper clad aluminum, the like, or a combination thereof. The foil layer 38 may comprise one or more conductor paths or conductor traces 40. By selecting a suitable material for the foil layer 38 and/or a suitable size or shape of the conductor paths or traces 40 (i.e., width, thickness, height, length, shape, material, etc.), the foil layer 38 and/or the one or more conductor paths or traces 40 may be, or may comprise, or may function as one or more electrical heating elements 42, one or more sensing elements 46, or both. In other configurations, one or more heating elements 42 and/or sensing elements 46 may be attached or connected to the one or more conductor paths or traces 40 via a suitable fastener, electrical connector, and/or adhesive, such as for example conductive adhesive, soldering, welding, etc. The one or more conductor paths or traces 40 may function to conduct or carry electrical energy and/or electrical communication signals between the heating blanket, heating segments, the controller, power source, or a combination thereof. In certain other configurations, it is envisioned that electrical power and/or electrical communication signals may be additionally or instead wirelessly communicated or transmitted between the elements of the heating system and/or heating blanket.

The one or more conductors or traces 40 or heating elements 42 may generate heat in response to electrical power or signals that are supplied to the heating segment. The one or more conductors or traces 40 or heating elements 42 may be one or more resistors, heating resistors, wire heaters or resistors, or a combination thereof. The one or more conductors or traces 40 or heating elements 42 may be one or more wire conductors attached, place, or integrated into the base layer, foil layer, or both. The one or more conductors or traces 40 or heating elements 42 may any other suitable heater that is configured to suitably perform one or more of the heating functions. The heating layer 28 may comprise any of the heating elements disclosed herein. The one or more heating elements 42 may be one or more PTC heaters.

The one or more sensing elements 46 may be configured to determine, sense, change, and/or monitor a temperature or heat generated by the heating layer and/or the one or more heating elements 42 or conductors or traces 40. The one or more sensing elements 46 may be one or more thermistors. The one or more sensing elements 46 may be one or more NTC thermistors (Negative Temperature Coefficient sensor). An NTC thermistor may be a non-linear resistor, which may alter its resistance characteristics with temperature. The resistance of NTC thermistor will decrease as the temperature generated by the heating elements 42 and/or sensed by the sensing elements 46. The one or more sensing elements 46 may be any other suitable sensor that is configured to suitably perform one or more of the sensing functions.

In some configurations, the foil layer 38 may be placed on the base layer 36 and/or connected thereto via one or more fasteners, or simply overlayed on the base layer 36. The foil layer 38 may then be subjected to an operation where certain portions of the foil layer 38 are removed from the base layer 38, while other portions of the foil layer 38 remain on the base layer 36. The operation may be a milling, grinding, etching, or other material removal operation. The portions of the foil layer 38 remaining on the base layer 36 after the operation may be the electrically conductive traces or conductor paths 40, one or more electrical heating elements 42, one or more sensing elements 46, or a combination thereof. Accordingly, the one or more electrically conductive traces or conductor paths 40, one or more electrical heating elements 42, one or more sensing elements 46, or a combination thereof may be integrally formed on the foil layer 38 and/or base layer 36. In the event that the foil layer 38 and the base layer 36 are formed as a single, integral layer, then the one or more electrically conductive traces or conductor paths 40, one or more electrical heating elements 42, one or more sensing elements or temperature sensors 46, or a combination thereof may be integrally formed on the base layer 36 after the material removal operation. Additionally, or alternatively, one or more heating elements 42, conductive traces or conductor paths 40, and/or sensing elements 46 may be subsequently attached or connected to the traces or conductor paths 40 or the remaining portions of the foil layer 38 after the material removal operation.

In some configurations, the foil layer 38 may be subjected to the aforementioned material cutting or removal operation to form the electrically conductive traces or conductor paths 40 and/or one or more electrical heating elements 42 before being installed or placed onto the base layer 36.

In some configurations, another foil layer 38′ may be subjected to another material removal operations to form the electrically conductive traces or conductor paths 40 sending elements 46. The another foil layer 38′ that includes the electrically conductive traces or conductor paths 40 sensing elements 46 may then be placed over and/or under the foil layer 38 which contains the electrically conductive traces or conductor paths 40 and/or one or more electrical heating elements 42. A laminate may then be placed over, under, and/or around the two layers to connect the two layers together. One or more of the electrically conductive traces or conductor paths 40 may be accessible through the laminate in order to attach one or more heaters and/or sensing elements thereto. In such a configuration, the one or more heating elements and/or sensing elements may be arranged above the laminating layer, while the one or more electrically conductive traces or conductor paths 40 are located below the laminate.

An outer laminating layer may be provided over, under, and/or around the base layer 36 and the foil layer 38 to connect, join, and/or maintain the position of the two layers 36, 38 together. The laminating layer may function to protect one or both of the layers 36, 38 from damage if liquid and/or solid contaminates enter the blanket 18 and/or penetrate one or more of the cover layers 26, 32 and/or insulating layers 30. The laminating layer may function to distribute heat generated by the heating layer 28 and/or the foil layer 38.

In some configurations, the foil layer 38 and/or the remaining portions of the foil layer 38 may be covered with a suitable material, cladding, and/or surface treatment to allow attachment or connecting of one or more heating elements 42, one or more electrical conductors 44, one or more sensing elements 46, or a combination thereof to the foil layer 38. This may be advantageous when the foil layer 38 is made of a material that is or includes aluminum. Because aluminum or other similar materials may oxidize on their surface that may inhibit or prevent solder or other attaching mechanism from bonding to it, a need may exist for a cladding (e.g., copper or like materials) and/or a surface treatment to be applied to the foil layer 38 before electrical components like heating elements 42, sensing elements 46, conductors 44, and/or the like can be attached thereto. An example of a surface treatment that may be applied to the aluminum and/or foil layer 38 is MINA, developed by AVERATEK.

The heating segment 34 may be a generally planar and/or elongated member or flexible sheet that comprises one or more heating sections 48 and one or more sensing sections 50.

The one or more heating sections 48 may comprise one or more heating elements that are configured to generate heat in response to a supply of electrical energy.

The one or more sensing sections 50 may comprise one or more sensing elements that are configured to monitor or determine an amount of heat generated by the one or more heating sections 48 or heating elements.

The sections 48 and 50 may be separate sections that are connected together in a subsequent forming operation, or the two sections 48, 50 may be integrally formed without having to attach or connect the two sections together.

The one or more heating sections 48 may be made of one or more carrier or base layers 36 and one or more foil layers 38. One or more dividers 52 may be provided or defined between two adjacent sections 48, 50. The sections 48, 50 and the divider 52 may be located in a common plane. The divider 52 may be electrically conductive or electrically non-conductive. While the divider 52 is illustrated as extending along an axis that is generally parallel to a longitudinal axis of the heating segment 34, it is understood that the divider 52 may extend along an axis that is perpendicular to a longitudinal axis of the heating segment 34 or located at any other angle besides parallel to the longitudinal axis of the heating segment 34. In other words, the divider 52 may extend at a diagonal or different angle relative to a longitudinal axis L of the heating segment 34. Furthermore, the size (i.e., width and/or length) of the two sections 48, 50 may be substantially the same or substantially different. In other words, a size (width and/or length) of one of the sections 48, 50 may be larger or greater than the other section 48, 50 or a size of the two sections may be generally the same.

The heating segment 34, the foil layer 38, or both, may include one heating zone 54 or a plurality of heating zones 54. For example, FIG. 3A illustrates four (4) heating zones 54, which are further identified as A-D and separated or defined between the dashed lines 55. The number of heating zones 54 can vary depending on the manufacturing process of making the heating segment 34 or heating layer. In other words, a short heating segment 34 may be made of, or comprise only one heating zone 54. Or, a longer heating segment 34 may be made of, or comprise virtually any number of heating zone 54 (e.g., two or more zone 54, five or more zone 54, ten or more zone 54, fifty or more zone 54, etc.). Advantageously, this means that a heating blanket 18 can be constructed having virtually any size (e.g., length or width) by varying the size (i.e., length or width) of the heating segment 34, which thus varies the number of heating segments 34.

While the plurality of heating zones 54 are illustrated as each having generally the same size (e.g., height and width), it is understood that each of the heating zones 54 may have a different size from one another (e.g., a different height and/or width relative to other heating zones 54). Each heating zone 54A, B, C, D may include one or more conductor paths or traces 40, one or more heating elements 42, one or more sensing elements 46, or a combination thereof.

In some configurations, one or more of the heating zones 54 have exactly one heating element 42 and exactly one sensing element 46. The heating element 42 may be the conductive trace 40 that extends or meanders within the heating zone 54. The extending or meandering heating element 42 or conductor 40 may meander or extend into the adjacent heating zones 54 or may be exclusively located in a single zone. The exactly one heating element 42 may be located in the heating section 48 and the exactly one sensing element 46 may be located in the sensing section 50. In some configurations, one sensing element 46 may be provided for each heating element 42 or for each pair of heating elements 42.

In some configurations, one or more of the sensing sections 50 may include one or more conductor paths or traces 40, one or more heating elements 42, one or more sensing elements 46, or a combination thereof. In some configurations, one or more of the sensing sections 50 may include one or more conductor paths or traces 40 and one or more sensing elements 46 but may be free of one or more heating elements 42.

An overlay or laminate may be placed over the foil layer 36, the base layer 36, or both. The overlay may function to protect the foil layer 38, the conductor paths or traces 40, any elements attached to the foil layer 38 and/or traces 40, or a combination thereof. For example, the overlay or laminate may protect the foil layer 38 and/or heating segment 34 from electrical shorting or other damage, for example if a liquid or other contaminants penetrates the cover layer(s) and/or enters the blanket. For example, the overlay may comprise a polyethylene terephthalate (PET) that is attached to the foil layer 36, base layer 36, or both via an adhesive such as a pressure sensitive adhesive (PSA).

The heating segment 34, the base layer 36, the foil layer 38, or a combination thereof may include one or a plurality of connecting regions 56. A connecting region 56 may be a portion of a heating segment 34, the base layer 36, the foil layer 38, the heating zone 54, or a combination thereof used for connecting or joining together multiple different heating segments 34, base layers 36, foil layers 38, heating zones 54, or a combination thereof. A connecting region 56 may permit electrical energy and/or electrical communication signals to be transferred, communicated, and/or conducted between or through adjacent and/or connected heating segments 34 and the controller 12, power source, etc. (FIG. 1). A connecting region 56 may be provided on any of the edges or perimeter of the heating segment 34, the base layer 36, the foil layer 38, heating zone 54, or a combination thereof. A connecting region 56 may also be located at the divider 52, as discussed below with reference to FIGS. 4A-6, or even at the divider 55. A connecting region 56 may comprise one or more conductors or traces that enables transmission or conduction of heat, electrical power, communication signals, or a combination thereof between different heating segments 34 and/or elements on the segments (traces, heating elements, sensing elements, etc.)

With additional reference to FIGS. 4A and 4B, a heating segment 34 can be manipulated from a generally planar construction illustrated in FIGS. 3A, 3B, 4A into a folded or 3-dimensional construction illustrated in FIG. 4B. The heating section 48 and/or the sensing section 50 may be folded or moved about the divider 52 (See arrow in FIG. 4A) so that the sections 48, 50 become juxtaposed or adjacent to each other as illustrated in FIG. 4B. In the folded configuration, the foil layer 38 of the sensing section 50 may face or may be adjacent or juxtaposed to the foil layer 38 of the heating section 48. However, in other folded configurations, the base layer 36 of the sensing section 50 may face or may be adjacent or juxtaposed to the base layer 36 of the heating section 48. In the folded configuration, the sensing section 50 and the heating section 48 are located in different, adjacent planes. The two planes may be generally parallel to each other, or the two planes may be slightly angled relative to each other, depending on the size of the divider 44 and/or the folding of the sections 48, 50 and how tight the fold is at the divider 52. The sensing section 50 comprises one or more sensing elements that are configured to monitor or determine an amount of heat generated by the one or more heating elements in the heating section 50 upon which it is now located adjacent to after folding.

Referring now to FIG. 5, the two heating segments 34, 34′ are connected, coupled, or joined together to form the heating layer 28 (or a portion of a heating layer 28 if additional heating segments 34 are subsequently connected to form a larger heating layer 28 and/or heating blanket 18). Each of the two heating segments 34, 34′ are folded into the configured illustrated in FIG. 4B. The two heater segments 34, 34′ can be connected, coupled, or joined together by abutting, joining together, or putting into contact the respective dividers 52, 52′. The coupled two heater segments 34, 34′ can be held together via suitable fasteners, such as welds, stitching, adhesives, tape, etc. Thus, the dividers 52, 52′ function as a connecting region 56 on each heating segment 34. When connected together via the dividers 52, 52′, electrical energy and/or signals may be communicated or conducted between the two heater segments 34, 34′. This means that the dividers 52, 52′ and/or connecting regions 56 include at least one electrical conductor 44 or path 40. The dividers 52, 52′ may also include one or more heating elements 42 and/or sensing elements 46.

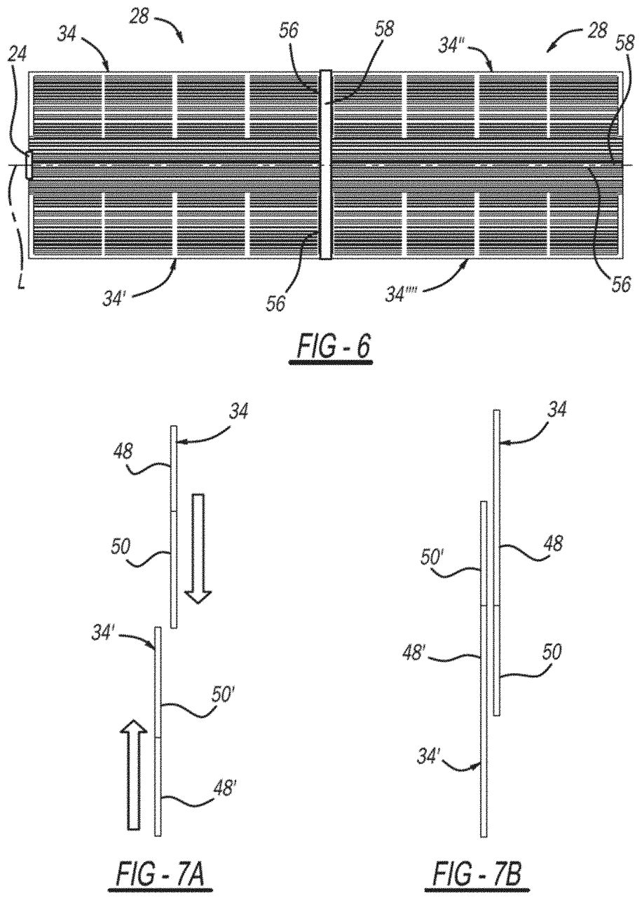

FIG. 6 illustrates a heating layer 28 or a portion of heating layer 28 that comprises four (4) heating segments 34, 34′, 34″, and 34′″. Heating segments 34 and 34′ are coupled together via the dividers 52, 52′ as shown in FIG. 5. Similarly, heating segments 34″ and 34′″ are coupled together via their respective dividers by folding the respective sections 48, 50 according to FIGS. 4A and 4B and coupling them together according to FIG. 5. The heating segments 34 and 34″ are then connected or coupled together via respective connecting regions 56 located or defined at the side edges thereof. Accordingly, electrical energy and/or signals may be communicated or conducted between all of the heater segments 34, 34′, 34″, and 34′″ and the controller and/or power source (FIG. 1).

In FIG. 6, an optional support 58 may be provided to assist with connecting the heater segments 34, 34′, 34″, and 34′″. The support 58 may be an adhesive tape. The support 58 may be electrically conductive so that electrical energy and/or signals may be communicated or conducted between all of the heater segments 34, 34′, 34″, and 34′″ and the controller or power source. The support 58 may be non-electrically conductive or may be an insulator. The support 58 may extend along a longitudinal axis L of the segments and/or heating layer 28. A similar support may also extend at the other regions of the connecting regions 56, for example, in the vertical regions between heater segments 34 and 34″ and 34′ and 34″.

The heating blanket 18, the heating layer 28, and/or one or more of the heating segments 34 may include one or more connectors 24. A connector 24 may be used to connect or couple the heating blanket 18, the heating layer 28, and/or one or more of the heating segments 34 to the controller 12 or power source. The connector 24 may be enabled to communicate, transmit, and/or conduct electrical energy and/or signals between the controller 12 and the one or more heating segments 34. The connector 24 may be electrically connected to the one or more conductor paths or traces 40, the support 58, the one or more connecting regions 56, or a combination thereof.

By connecting or joining together two or more heater segments 34, a heating layer 28 and/or blanket 18 of any size may be constructed. Advantageously, this means that a common machine and/or process may be used to construct commonly sized and shaped heater segments 34 that can then be manipulated, arranged, and/or joined together with other similar heater segments 34 to form a heating layer 28 and/or blanket 18 of any desired shape or size.

FIGS. 7A and 7B illustrate another exemplary method of joining together two or more heating segments 34, 34′. The heating segments 34, 34′ are brought together such that the sensing section 50 of heating segment 34 is juxtaposed or placed adjacent to or in contact with the heating section 48′ of heating segment 34′ and the sensing section 50′ of heating segment 34′ is juxtaposed or placed adjacent to or in contact with the heating section 48 of heating segment 34. In such a connection, the foil layer of the sensing section 50 may face or may be adjacent or juxtaposed to or in contact with the foil layer of the heating section 48′. However, in some folded configurations, the base layer of the sensing section 50 may face or may be adjacent or juxtaposed to or in contact with the base layer of the heating section 48′.

The sensing section 50 or the one or more sensing elements of sensing section 50 of heating segment 34 is configured to monitor or determine an amount of heat generated by the one or more heating elements of the heating section 48′ of heating segment 34′. The sensing section 50′ or the one or more sensing elements of sensing section 50′ of heating segment 34′ is configured to monitor or determine an amount of heat generated by the one or more heating elements of the heating section 48 of heating segment 34.

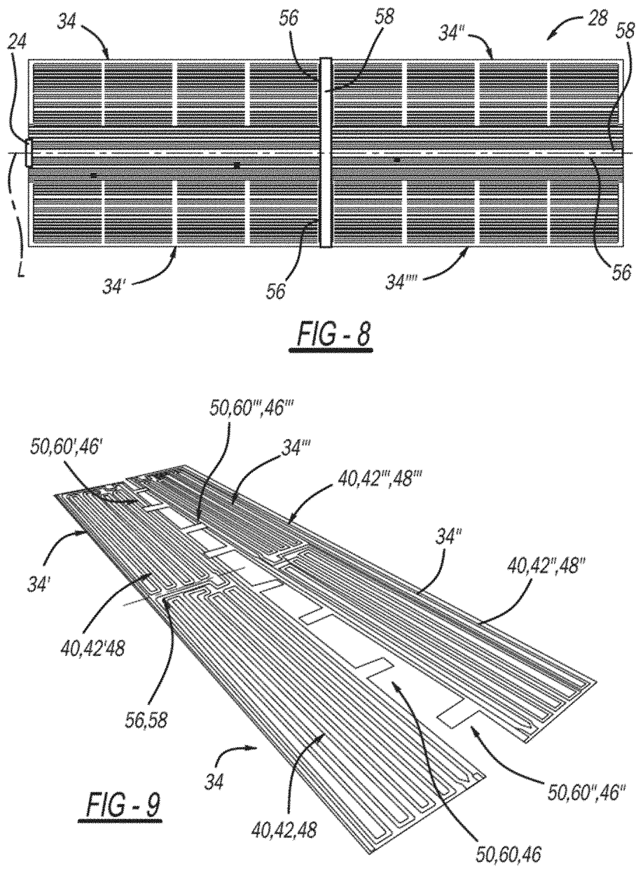

FIG. 8 illustrates a heating layer 28 or a portion of heating layer 28 that comprises four (4) heating segments 34, 34′, 34″, and 34′″. Heating segments 34 and 34′ are coupled as shown in FIG. 7B. Similarly, heating segments 34″ and 34′″ are also coupled according to FIG. 7B. The heating segments 34 and 34″ are then connected or coupled together via respective connecting regions 56 at the side edges thereof. Accordingly, electrical energy and/or signals may be communicated or conducted between all of the heater segments 34, 34′, 34″, and 34″.

An optional support 58 may be provided to assist with connecting the heater segments 34, 34′, 34″, and 34′″. The support 58 may be an adhesive tape. The support 58 may be electrically conductive so that electrical energy and/or signals may be communicated or conducted between all of the heater segments 34, 34′, 34″, and 34′″ and the controller or power source. The support 58 may be an insulator or non-electrically conductive. The support 58 may extend along a longitudinal axis L of the segments and/or heating layer 28. A similar support may also extend at the other regions of the connecting regions 56, for example, in the vertical regions between heater segments 34 and 34″ and 34′ and 34′″.

The heating blanket 18, the heating layer 28, and/or one or more of the heating segments 34 may include a connector 24. The connector 24 may be used to connect or couple the heating blanket 18, the heating layer 28, and/or one or more of the heating segments 34 to the controller 12. The connector 24 may be enabled to communicate, transmit, and/or conduct electrical energy and/or signals between the controller 12 and the one or more heating segments 34. The connector 24 may be electrically connected to the one or more conductor paths or traces 40, the support 58, the one or more connecting regions 56, or a combination thereof. The connector 24 may be directly connected to one of the heating segments 34, and signals may be passed from the heating segment 34 that is directly connected to the connector 24 to the other heating segments 34′, 34″, and 34′″ that are connected to the heating segment 34. Alternatively, the connector 24 may be directly electrically connected to more than one heating segment.

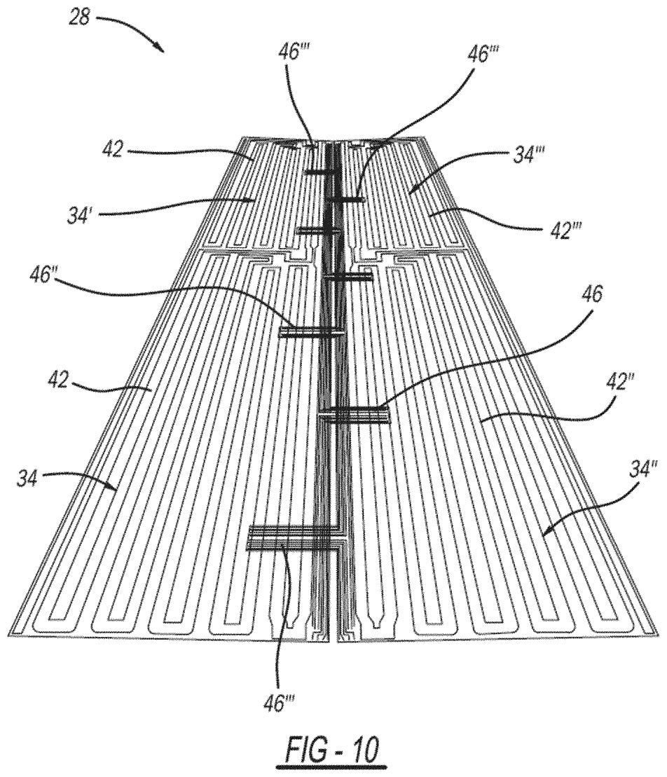

FIG. 9 illustrates a heating layer 28. The heating layer 28 comprises plural heating segments 34, 34′, 34″ and 34′″. Remarks regarding the heating layer 28 from any of the figures and/or paragraphs herein may apply to FIG. 9 and vice versa. The heating layer 28 may include only heating segments 34 and 34″ and/or only heating segments 34′ and 34′″.

The heating segments 34, 34′ may be integrally formed or may be connected at a connecting region 56 or by a support 58. Similarly, the heating segments 34″, 34′″ may be integrally formed or may be connected at a connecting region or by a support. In other configurations, the heating segments 34, 34′ and/or 34″, 34′″ may be separated at the connecting region 56 by a cutting, slicing, or separating operation. The separated heating segments may be joined with other heating segments to make the heating layer 28. Alternatively, a heating layer 28 may be made with only one of the heating segments 34, 34′ and/or 34″, 34′″.

Each heating segment 34, 34′, 34″, 34″ comprises one or more heating sections 48 having one or more conductor paths or traces 40 and/or one or more heating elements 42. Each heating segment 34, 34′, 34″, 34″ comprises one or more sensing sections 50. Each sensing section 50 comprises one or more fingers 60, 60′, 60″, 60′″ projecting or extending or cantilevering from a long edge of the respective heating segment. The fingers may also or instead project from one or more short edges of the heating segment and/or from both long edges of a heating segment. The sensing sections 50 and/or fingers 60 may be integrally formed or formed as separate components and connected together using one or more of any of the fasteners disclosed herein. Each finger comprises one or more conductor traces 40 and/or sensing elements 46, 46′, 46″, 46′″. The heating segments 34, 34′, 34″ and 34′″ may include one or more other features disclosed in any of the figures herein and/or description.

Referring back to FIGS. 3A-7B, the sensing sections 50 in FIGS. 3A-7B may have a sheet-like structure projecting from the edge of the heating section 48. In contrast, the sensing sections 50 in FIGS. 8-11 may be fingers or teeth or other projections that extend from an edge of the heating section 48. In other words, a gap of void or absence of material may be defined between adjacent sensing sections 48. The gap between adjacent sensing sections 48 may be tuned to obtain accurate temperature readings from the corresponding heating section.

FIG. 10 illustrates the heating segments 34, 34′, 34″, 34″ of FIG. 9 joined or connected together to form a heating layer 28. More specifically, a finger or sensing element is configured to contact or sense heat provided or generated by an adjacent heating section in a different heating segment. Stated another way, referring to both FIGS. 9 and 10, the one or more fingers 60 or sensing elements 46 overlap or are positioned or placed on or below the heating segment 34″ or heating elements 42″; the one or more fingers 60′ or sensing elements 46′ overlap or are placed on or below the heating segment 34′″ or heating elements 42′″; the one or more fingers 60′″ or sensing elements 46′ overlap or are placed on or below the heating segment 34′ or heating elements 42′; the one or more fingers 60″ or sensing elements 46″ overlap or placed on or below the heating segment 34 or heating elements 42′.

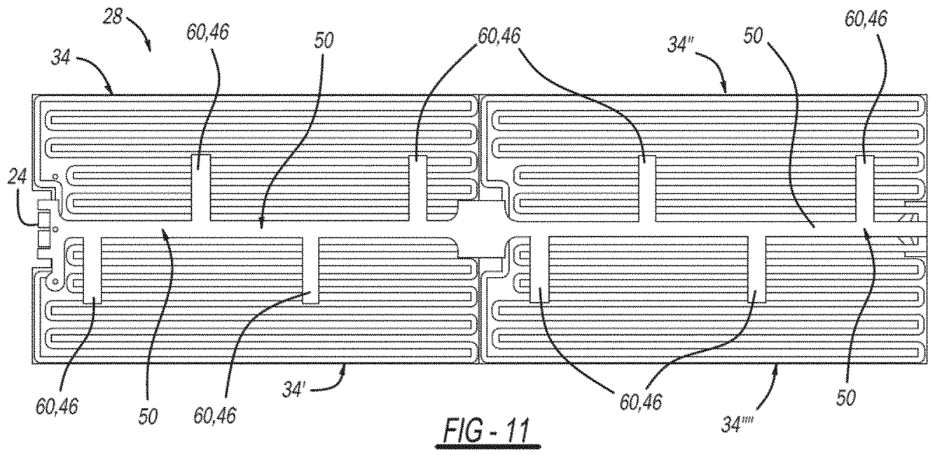

FIG. 11 illustrates another heating layer 28 that includes heating segments 34, 34′, 34″, and 34′. Remarks regarding the heating layer 28 from any of the figures and/or paragraphs herein may apply to FIG. 11, and vice versa. In some configurations, the heating layer 28 may include only one heating segment, or more than the four segments shown in this figure. Also, the heating segments may be arranged in any pattern or orientation. For example, while the heating segments of FIG. 11 are arranged to form a rectangular heating layer 28, the segments may be arranged to form other shapes, such as a square, L-shape, T-shape, J-shape, I-shape, etc. This applies to any of the other heating segments and/or layers herein.

The heating layer 28 may include any number of heating segments (i.e., the layer 28 can have as little as one segment or any plurality of segments). The heating layer 28 may include the elements or features illustrated and described in the previous figures. In FIG. 11, however, the sensing section 50 is a separate piece or layer than the one or more heating sections 48 and/or heating segments 34, 34′, 34″, and 34′″. In other words, one or more of the heating segments 34, 34′, 34″, and 34′″ may be one or more layers that include the one or more conductor paths or traces 40 and/or one or more heating elements 42, and then a separate layer or sheet that includes the sensing section 50 (e.g., the one or more sensing elements 46 and connecting traces 40) may be applied onto (i.e., placed above and/or below) the one or more heating segments 34, 34′, 34″, and 34′″. The two layers may be connected or attached via one or more fasteners or adhesives, for example: tape, welding, pins, switches, hook and loop fasteners, adhesive pastes. Additionally, or alternatively, a laminate may be provided above, below, and/or around the sheets to join and maintain the layers together. The adhesives, fasteners, and/or laminate may function to restrict or prevent any relative movement between the two sheets.

The edges or connecting regions 56 (See FIG. 3A) of each heating segment 34, 34′, 34″, and 34′″ may be brought together and connected to each other via one or more supports or other mechanisms. The sensing section 50 may then be provided over and/or below each of the one or more heating sections 48. The sensing section 50 may be attached to the heating segments.

The sensing section 50 comprises one or more fingers 60 having sensing elements 46 for sensing heat generated by each of the one or more heating sections 48. The heating elements 42 and/or sending elements 46 can be electrically connected via one or more traces to an edge region of the heating layer 28, to the connector 24.

FIGS. 12 and 13 illustrate the heating layer 28. The heating layer 28 may include any of the features, elements, and/or description in any of the figures and paragraphs disclosed herein, and any of the teachings in FIGS. 12 and 13 may be applied to any of the other Figures and/or paragraphs herein.

The heating layer 28 may include one or more slits, slots, cuts, voids, tears, openings, apertures, absence of material 74, which will hereafter be referred to herein as one or more slits 74. The one or more slits 74 may be arranged anywhere on the profile of the heating layer 28 (e.g., along the edges, in a center region, at a top region, bottom region, left region, right region, etc.). One or all of the heating segment 34, 34′, 34″, 34″ may include one or more slits 74. One or all of the heating segments may be free of any slits 74. The one or more slits may extend through one or more or all layers of the heating layer 28, for example, through the layer that includes the one or more conductor paths or traces 40 and/or one or more heating elements 42, the layer that includes the sensing section 50, and/or the laminating layer that surrounds the two aforementioned layers.

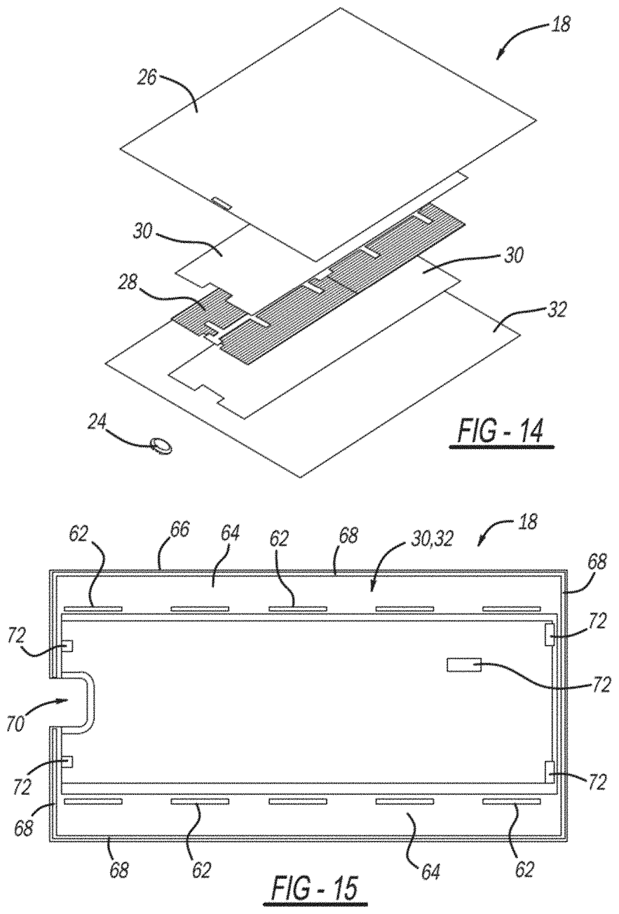

The one or more slits 74 may function to add flexibility to the heating layer 28 to allow the heating layer 28 and/or blanket 18 to confirm to the surround areas and/or a patient's body as shown in FIG. 14. One or more of any of the other layers of the blanket 18 discussed herein (e.g., the one or more insulation layers and/or the one or more cover layers) may include similar slits 74 to further provide flexibility and ability for the blanket 18 to conform to the surroundings and/or a patient. One or more of any of the layers discussed herein may be free of any slits.

The one or more slits 74 may be provided in regions that are free of any conductors, heaters, sensors, etc. The one or more slits 74 may be continuous and meander and/or extend along an entire length of the heating layer 28, or the one or more slits may be discrete, individual slits 74 scattered along the length or profile of the heating layer 28. The one or more slits may have any shape (circular, square, rectangle, triangle, etc.). The one or more slits may be perforations. In some instances, the one or more slits may not extend through the entire thickness of the layer. Instead, a slit may be a thinned, recessed, or scalloped part of the material. In other words, such a slit may be thinner region of the material thickness of the particular layer.

In some configurations, one or more attachment features may be passed through the one or more slits 74. For example, one or more attachment features that connect the layers of the blanket (e.g., cover layer 30, 32, heating layer 28, insulating layers 30) may pass through the one or more slits 74 in the heating layer 28. This may provide for the layers to be connected together without having or bond, pierce, or attach directly to the heating layer 28. Instead, the attachment may pass through a void of slit 74 already defined in the heating layer 28 before being assembled to the blanket 18. The attachment feature may be any attachment feature disclosed herein (e.g., weld, stich, button, clasp, rivet, hook and loop fastener, heat stake, magnet, etc.).

FIG. 14 illustrates the heating blanket 18. The heating blanket 18 may comprise one or more layers. The one or more layers may include: a top or first cover layer 26, a heating layer 28, a plurality of insulating layers 30, a bottom or second cover layer 32 and one or more connectors or plugs 24. All remarks regarding the heating blanket 18 illustrated and described in any of the figures and/or paragraphs may apply to the blanket illustrated in FIG. 14 and vice versa.

One or both of the cover layers 26, 32, may have a size that is greater than or larger than one or more of the other middle layers of the blanket 18, like the heating layer 28 and/or the insulating layers 30.

It is understood that a blanket 18 and/or heating layer 28 may be constructed by combining the teachings in any of the Figures. This may further provide the ability to construct a custom sized heating blanket and/or heating layer 28 without having to manufacture heating layers 28 or heating segments 34 of various sizes.

With additional reference to FIG. 15, an assembled blanket 18 is shown. The blanket 18 includes a first attachment region 62. The first attachment region 62 may be located within or inside a periphery or edges of 66 of the blanket 18 (e.g., within the perimeter or outside or outer most edge of the blanket 18 or the cover layers 30, 32). The first attachment region 62 may join attach or connect together one or more layers of the blanket 18. For example, the first attachment region 62 may connect or join together the cover layers 30, 32. However, it is within the scope of this disclosure that the first attachment region 62 may also connect together one or more of the other middle layers 28, 30 of the blanket 18.

The first attachment region 62 may surround the entire perimeter of the heating layer 28 or other middle layers like an insulation layer so that the heating layer 28 and/or other middle layers are contained within a pouch or envelope defined by the cover layers 30, 32 within a boundary of the first attachment region 62. Alternatively, the first attachment region 62 may not extend around an entire perimeter of the heating layer 28; instead, the first attachment region 62 may be arranged adjacent one or more edges of the heating layer 28, two or more edges, three or more edges, etc. For example, in FIG. 15, the first attachment region 62 is illustrated adjacent two opposing edges of the heating layer 28.

The first attachment region 62 may be formed with suitable attachment or connection elements, such as welding stitching, adhesives, clamps, pins, hook and loop fasteners, snaps, buttons, clasps, tape, and the like. The first attachment region 62 may be a continuous region. This means that there are no gaps, spaces, or absence of attachment material in the first attachment region 62. Alternatively, the first attachment region 62 may be intermittent—this means there may be spaces, gaps, or absence of attachment material in the first attachment region 62. For example, if the first attachment region 62 comprises welding (e.g., ultrasonic, RF, etc.), then there may be gaps, spaces, or absence of weld material adjacent to sections that include the weld material. Air may pass through the gaps, spaces, or absence of weld material such that there is no hermetic seal of the layers inside of the pouch. Alternatively, if the first attachment region 62 is continuous and comprises welding, then there are no gaps, spaces, or absence of welding in the attachment region 62. A hermetic seal may be achieved in such a configuration, such that there is little or no exchange of air between the inside pouch containing the one or more layers and the region on the other side of the attachment region 62.

The heating blanket 18 may include one or more flaps 64. The one or more flaps 64 may be regions of the blanket 18 between the first attachment region 62 and an outermost edge 66 of the blanket 18, the one or more layers, the one or more cover layers 30, 32, or a combination thereof. The one or more flaps 64 may be arranged along the long edges of the blanket 18, the short edges of the blanket 18, or both. One or more of the long edges and/or short edges may be free of a flap 64.

The one or more flaps 64 may be free of any middle layers, except for one or both of the cover layers 30, 32. Alternatively, the one or more flaps 64 may also include one or more of the middle layers (i.e., heating layer 28, insulation layers 30, or both.) The one or more flaps 64 may be used to secure the blanket 18 to a bed, stretcher, floor, around a patient, or a combination thereof. For example, the one or more flaps 64 may be tucked under a patient or mattress or secured to a frame to prevent the blanket 18 from moving or falling off. The one or more flaps 64 may be used to hang the blanket when not in use.

The heating blanket 18 may include a second attachment region 68. The second attachment region 68 may join attach or connect together one or more layers of the blanket 18. For example, the second attachment region 68 may connect or join together the cover layers 30, 32. However, it is within the scope of this disclosure that the second attachment region 68 may also connect together one or more of the other layers 28,8, 30 of the blanket 18.

The second attachment region 68 may be located at or near the outermost edge or perimeter 66 of the layers and/or blanket 18. The second attachment region 68 may be arranged around an entire perimeter of the heating layer 28. The second attachment region 68 may not be arranged around an entire perimeter of the heating layer 28; instead, the second attachment region 68 may be arranged adjacent to one or more edges of the blanket 18. The blanket 18 may be free of the second attachment region 68 and/or the first attachment region 62 in a region 70 where the connector 24 connects to the blanket 18 and/or heating layer 28. By being free of the second attachment region 68 in this location (and also possibly free of the first attachment 62), access to the one or more inner layers or the heating layer 28 may be provided so that one or more connectors 24 and/or plugs can be connected to the heating layer 28.

The second attachment region 68 may be formed with suitable attachment or connection elements, such as welding stitching, adhesives, clamps, pins, hook and loop fasteners, snaps, buttons, clasps, tape, and the like. The second attachment region 68 may be a continuous region. This means that there are no gaps, spaces, or absence of attachment material in the second attachment region 68. A continuous second attachment region 68 may or may not provide a hermetic seal within the blanket. The second attachment region 68 may be intermittent—this means there may be spaces, gaps, or absence of attachment material in the second attachment region 68. For example, if the second attachment region 68 comprises welding (e.g., ultrasonic, RF, etc.), then there may be gaps, spaces, or absence of weld material. An intermittent second attachment region 68 may be free from providing a hermetic seal, meaning air can pass through the second intermittent attachment region 68. Alternatively, if the second attachment region 68 is continuous and comprises welding, then there are no gaps, spaces, or absence of welding in the attachment region 68 and air may be restricted or prevented from passing through the attachment region 68.

The heating blanket 18 may include a third attachment region 72. The third attachment region 72 may join, attach, or connect together one or more layers of the blanket 18. For example, the third attachment region 72 may connect or join together two or more of the inner layers of the blanket 18, like the one or more heating layers 28 and one or more insulating layers 30. For example, the third attachment region 72 may connect or join together one or more of the inner layers of the blanket 18, like the one or more heating layers 28 and one or more insulating layers 30 to one or more of the cover layers 30, 32. The third attachment region 72 may be a tape or adhesive that is between or sandwiched between two or more of the layers 26, 28, 30, 32 of the heating blanket 18. The third attachment region 72 may be a tape or adhesive that is provided around edges of two or more of the inside layers 28, 30 of the heating blanket 18, or both. The third attachment region 72 may be anywhere, including attaching the outer edges or perimeter of the layers. The third attachment region 72 may be anywhere, including on or between the faces or profiles of the layers, between the outer edges or perimeter. The third attachment region 72 may be formed with suitable attachment or fastening elements, such as welding stitching, adhesives, clamps, pins, hook and loop fasteners, snaps, buttons, clasps, tape, double sided tape, PSA, and the like.

FIG. 16 illustrates the heating blanket 18. The heating blanket 18 may comprise one or more layers. The one or more layers may be selected from: a top or first cover layer 26, a heating layer 28, a plurality of insulating layers 30, a bottom or second cover layer 32 and one or more connectors or plugs 24. All remarks regarding the heating blanket 18 illustrated and described in any of the figures and/or paragraphs may apply to the blanket illustrated in FIG. 12 and vice versa.

It is understood that a blanket 18 and/or heating layer 28 may be constructed by combining the teachings in any of the Figures. This may further provide the ability to construct a custom sized heating blanket and/or heating layer 28 without having to manufacture heating layers 28 or heating segments 34 of various sizes.

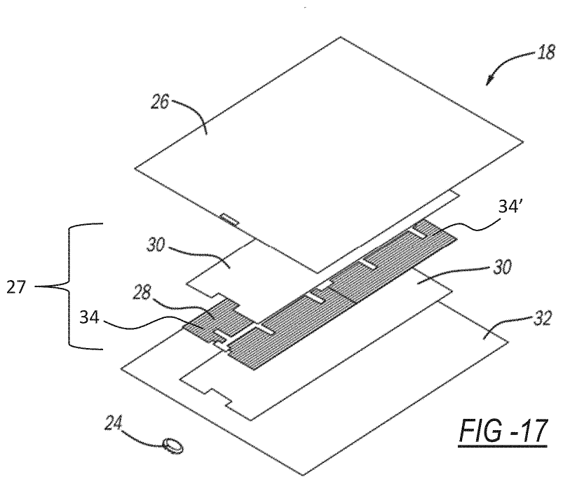

FIG. 17 illustrates a heating blanket 18. The heating blanket 18 may comprise one or more layers or sheets. The one or more layers or sheets may comprise: one or more top or first cover layers 26, one or more heating layers 28, one or more insulating layers 30, one or more bottom or second cover layers or bottom layers 32, one or more connectors or plugs 24, or a combination thereof. The blanket 18 may have an insulating layer 30 on both sides of the heating layer 28, with the heating layer 28 sandwiched therebetween.

One or both of the cover layers 26, 32, may have a size that is greater than or larger than one or more of the other middle layers 27 of the blanket 18, like the heating layer 28 and/or the insulating layers 30.

The top or first cover layer 26 may be arranged on top of the heating layer 28, which may be arranged on top of the insulating layer 30, which may be arranged on top of the bottom or second cover layer 32. However, it is understood that any of these layers may be arranged in any order. For example, the heating layer 28 may be arranged below the insulating layer 30. Additionally, or alternatively, one or more of these layers may be combined into a single layer. For example, the heating layer 28 and the insulating layer 30 may be combined into a single layer (by attaching the layers together or forming them from an integral layer, for example). Additionally, or alternately, one or more of the blanket layers may be duplicated. For example, another one or more insulating layers 30 may be provided below or above the heating layer 28 and/or one or more additional heating layers 28 may be provided above or below one or more insulating layers 30. In some configurations, one or more of the layers may be joined together via one or more fasteners or may even be formed from an integral layer. The one or more fasteners may be one or more pins, buttons, clasps, welds, stiches, hook and loop fasteners, adhesives, pastes, screws, zippers, tape, double sided tape, magnets, snaps, heat stakes, etc.

In some configurations, the first and second cover layers 26, 32 may be formed from a single cover layer. For example, if constructed as a single cover layer, it can be folded over itself to cover, sandwich, and/or envelope the one or more other middle layers of the blanket 18 (e.g., one or more insulating layers 30, heating layers 28, etc.) therewithin or therebetween.

In some configurators, the first and second cover layers 26, 32 may be formed from a single cover layer or joined together to function or act like a duvet or pillowcase with one or two or three open ends. If there are two open ends, they may oppose one another, or adjoin one another. The one or more middle layers of the blanket 18 (e.g., one or more insulating layers 30, heating layers 28, etc.) may be inserted or slid into the duvet or pillowcase structure through one or more of the open ends. The one or more open ends may then be closed via one or more of any of the fasteners disclosed herein. Alternatively, one or both of the open ends may remain open. This may enable or provide for the middle layers of the blanket to be removed from within the cover for service, maintenance, and/or replacement of one or more of the layers, washing or sterilizing of the cover, or both. Alternatively, the one or more fasteners used to close the one or more open ends may be opened and closed (e.g., via snaps, buttons, hook and loop fasteners, zippers, etc.) to access and/or remove/install the middle layers. One or more of any of the middle layers of the blanket 18 may be eliminated or omitted or duplicated.

In some configurations, the top or cover layer 26 may be the same as the bottom cover layer 32 (i.e., same, or similar material, structure, composition, size, etc.). In other configurations, the two cover layers 26, 32 may be different (i.e., different material, structure, composition, size, etc.) This means, one of the cover layers 26, 32 may be made from a different material, may include additional or different insulating or heat deflecting/reflecting properties, etc. In some configurations, the top layer 26 should always face up or away from the patient, and the bottom layer 32 should always face down or towards a patient or bed, or vice versa.

One or both of the cover layers 26, 32 may be made from suitable material that allows heat generated by the heating layer 28 to pass through or be conducted from the heating layer 28 to warm a patient or object near or in contact with one or more layers of the blanket 18 or proximate or adjacent to one or more layers of the blanket 18. The cover layer 26, 32 material may be made of a suitable material that resists liquid (i.e., blood, disinfectants, water, cleaners, chemicals, etc.) absorption and/or penetration. This may advantageously protect the inside layers and elements of the heating blanket 18 from damage from liquid penetration. For example, one or both of the cover layers 26, 32 may be made of one or more materials that include: a nonwoven fabric, sheet, or material; a spunbond or spunlaid fabric, sheet, or material; a polypropylene fabric, sheet, or material; an LDPE film or coating applied onto one or both layers; or a combination thereof. Other materials that meet medical use specification requirements may be utilized, including any of the materials disclosed herein for any of the other blanket layers. In some configurations, one or both of the cover layers 26, 32 may be made of a suitable material that can be washed, wiped clean, autoclaved, and/or disinfected so that the blanket 18, one or both of the cover layers 26, 32 can be reused.

One or both of the cover layers 26, 32 may function to surround the one or more other layers of the blanket 18. One or both of the cover layers 26, 32 may provide a fluid resistant or fluid proof layer so that the other layers or elements of the blanket 18 can be protected from various fluids, blood, and other potentially damaging fluids or matters. One or both of the cover layers 26, 32 may function to provide a soft feel to comfort a user or patient using the blanket 18.

The heating blanket 18 may include one or more heating layers 28. The heating layer 28 and/or heating elements of the heating layer 28 may be configured or enabled to generate heat. The heating layer 28 may generate heat by converting electrical energy supplied by the controller 12 and/or one or more power supplies into heat energy. The heating layer 28 may include one or more heating segments, discussed further below. If the heating layer 28 comprises two or more heating segments, the heating segments may be individual components that are subsequently joined together to form the heating layer 28.

The one or more power supplies or sources may be one or more batteries, wall outlets, AC power, DC power, or a combination thereof. The blanket 18 and/or the heating layer 28 may include one or more connectors or plugs 24 for communicating with the controller 12 and/or power supply (FIG. 1) via the one or more cables 14, 16.

The blanket 18 may include one or more insulating layers 30. The insulating layer 30 may be made from a suitable material that functions to insulate or retain heat generated by the heating layer 28. The insulating layer 30 may conduct or direct or redirect the heat generated by the heating layer 28 in a particular direction, for example, in a direction towards a user or patient as opposed to away from the user or patient, or vice versa. The insulating layer 30 may function to direct or distribute or conduct heat generated by the heating layer 28 partially across or across the surface of the heating blanket 18 to reduce any isolated hot and/or cold spots. The insulating layer 30 may function to direct or distribute heat generated by the heating layer 28 to certain areas or regions of the blanket 18, and prevent the heat generated by the heating layer 28 to be directed or distributed to other layers of the blanket 18.

For example, the insulating layer 30 may be made of one or more materials that include a fleece material. Other materials that meet medical use specification requirements may be utilized, including any of the materials disclosed herein for any of the other blanket layers. The insulating layer 30 may be attached or bonded to any of the layers of the heating blanket. The insulating layer 30 may be free from direct attachment to any of the layers of the heating blanket. For example, the one or more insulating layers 30 may be attached to one or more heating layers 28, one or more other insulating layers 30, one or both of the cover layers 26, 32, or a combination thereof via one or more of any of the fasteners disclosed herein (i.e., pins, buttons, clasps, welds, heat weld, heat adhesive, stiches, hook and loop fasteners, adhesives, pastes, screws, zippers, tape, etc.)

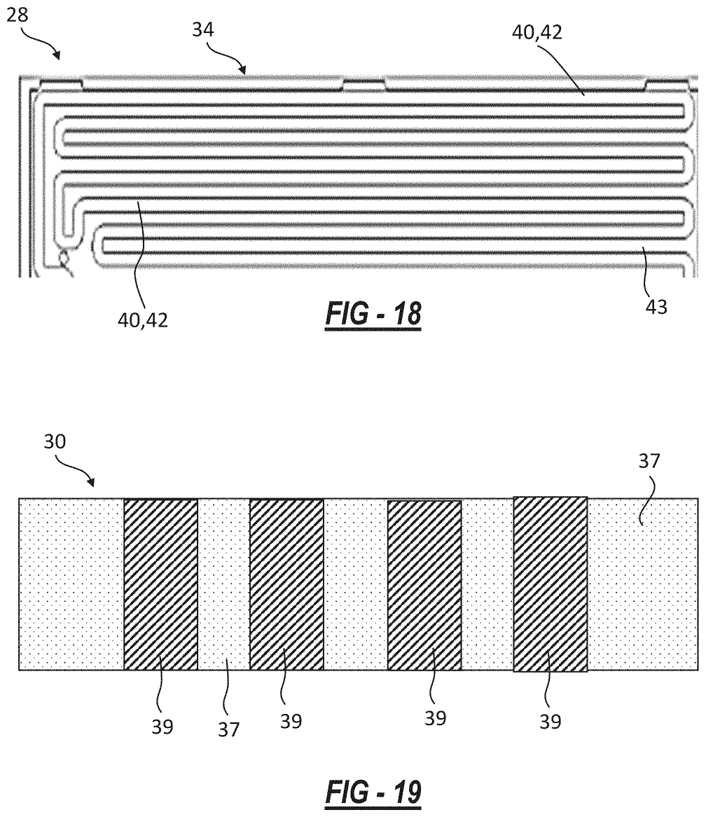

FIG. 18 illustrates a heating layer 28. The heating layer 28 may comprise one or more heating elements 42 disposed on a substrate 43. The heating layer 28 illustrated may be a heating segment 34. Two or more segments 34 may be joined together to make a heating layer 28. The substrate 43 may be an insulating or conductive film or foil or carrier. The heating layer 28 and/or the one or more heating elements 42 that may function to generate, produce, and/or emit heat. The one or more heating elements 42 may be one or more wires, resistive wires, conductors, traces, or a combination thereof. The one or more heating elements 42 may be arranged or disposed across an entire area of the heating layer 28 or substrate 43 or only at certain locations thereof. For example, the one or more heating elements 42 may be wires or traces that meander across or along certain regions of the heating layer 28 or substrate 43. The one or more heating elements 42 may be connected together via one or more conductor traces. The one or more conductor traces may be connected to the one or more or plugs 24 (FIGS. 1-2) for connecting to the one or more controllers 12 for supplying energy or power to the heating elements 42. The one or more heating elements 42 may meander across the entire substrate, or only along certain regions thereof. A size or cross section of the one or more heating elements 42 may be the same or uniform across the substrate 43. A size or cross section of the one or more heating elements 42 may be different or vary across the substrate 43, which may advantageously function to provide additional heating in certain desired areas and less heating in other areas. The heating layer 28 may be made of one or more or two or more heating segments, discussed further below, and illustrated at FIGS. 28-34.

FIG. 19 illustrates an exemplary insulating layer 30. The insulating layer 30 may cover a substantial portion of the heating layer 28. However, in some configurations, the insulating layer 30 may only cover certain, local regions of the heating layer 28, for example regions of the heating layer 28 where the heating elements 42 are located or where hot spots are detected. The heating blanket may be free of any insulating layer 30 in regions that do not have hot spots (temperature output at or below a predetermined threshold) or in regions that have cold spots (temperature output below a predetermined threshold).

The insulating layer 30 may comprise an insulating substrate 37 and one or more insulating mask sections 39. The insulating mask section 39 and the insulating substrate 37 may both function as insulators, but the insulating mask section 39 may insulate or block more heat than the insulating substrate 37. That is, the insulating substrate 37 may have lower insulating properties compared to the mask sections 39. The insulating substrate 37 may function to hold or join together the various sections of the insulating mask sections 39. In some configurations, the insulating substrate 37 may be eliminated and only the mask sections 39 may be attached or associated with the heating layer 28, as discussed in the later figures.

The substrate 37 may have generally the same size and shape as the heating layer 28. Alternatively, the substrate 37 may be smaller than the heating layer 28 and only be provided in regions where the heating elements 42 are located. In other configurations, the substrate 37 may be omitted or eliminated and the heating blanket or system may only include the mask sections 39. In some configurations, the mask sections 39 may be individual, discrete sections that are placed on the heating layer 28, in regions where the heating elements 42 are located and/or in regions of the heating blanket that produce hot spots or regions where the temperature is warmer than other regions. The mask sections 39 may function to locally block or reduce the amount of heat generated by the heating elements 42 to achieve a generally even heat output across the heating layer 28 and/or blanket.

The one or more insulating mask sections 39 may correspond to the location of the one or more heating elements on the heating layer. That is, the one or more insulating mask sections 39 may be applied locally over and/or under the location of the one or more heating elements. The one or more mask sections 39 may be applied locally or in select regions of the heating layer 28, where hot spots or regions of the heating layer 28 are detected or are warmer or hotter than other regions or areas, regardless of the location of the one or more heating elements 42. For example, the one or more insulating mask sections 39 may be locally applied to any region of the heating layer 28 where a temperature of the heating layer 28 is detected or determined to be higher than other areas of the heating layer 28. This will advantageously allow for the system to be tuned or specific hot spots to be locally compensated for to achieve a generally uniform heating output across the surface of the blanket. The one or more mask sections 39 may have a meandering pattern or structure, that mirrors the pattern, layout, or structure of the heating elements 42 on the heating layer 28.

The insulating substrate 37 may be present in regions of the heating layer 28 that is free of any heating elements 42 and/or conductors 40, for example, in between the heating elements 42. However, in some configurations, the insulating substrate 37 may be provided in regions where the heating elements 42 and/or conductors 40 are located. The insulating substrate 37 may be present in regions of the heating layer 28, that are cooler than other regions. The insulating substrate 37 may connect together the one or more insulating mask regions 39.

The insulating substrate 37 and the one or more insulating mask regions 39 may be made of the same materials or different materials. The insulating substrate 37 may have a different cross-sectional thickness than the insulating mask region 39. For example, the insulating mask region 39 may have a thicker cross section than a cross section of the insulating substrate 37, which may lead to more temperature insulation by the mask region 39 than the substrate 37.

The insulating substrate 37 and the one or more insulating mask regions 39 may be made of different materials or materials having different thermal properties. For example, the insulating mask region 39 may have a different thermal conductivity than the insulating substrate 37. The insulating mask region 39 may have a higher thermal conductivity than the insulating substrate 37, or vice versa.

The insulating substrate 37 and the one or more insulating mask regions 39 may be made of a fleece material. The fleece material may be die cut and applied to the heating layer 28; to the regions of the heating elements 42; heating conductors 40; or any regions in between. The fleece material may be applied to the heating layer 28 and then select regions of the fleece material may be removed via a cutting, laser, or punching operation. The fleece material may be a non woven material. The fleece material may be or may include a polyester material.

The fleece material of the substrate 37 and/or mask region 39 may have a thickness on the order of about 0.1 mm or more, 0.2 mm or more, 0.5 mm or more, 1 mm or more, 1.5 mm or more, 2 mm, or more, 3 mm or more, 4 mm or more. The thermal conductivity of the fleece material may be in the range of about 0.03-0.06 w/m-k (watts per meter-kelvin). However, in some configurations, a fleece material having a thermal conductivity of less than 0.03 w/m-k or more than 0.06 w/m-k may be preferred to achieve the desired benefit of reducing hot spots. The thickness or thermal conductivity of the fleece may be varied across the heating layer, to compensate for differences in hot spots. That is, certain regions may require more insulation or fleece than others, in order to achieve the desired result of a generally uniform heat output. In some configurations, the insulation or fleece may be reduced after assembly, for example, in cold spot regions, to allow the cold spot region to generate more heat to achieve a generally uniform heat output across the entire surface of the heating blanket.

The insulating substrate 37 and the one or more insulating mask regions 39 may be made of a flocking material. The flocking material may be made by extruding fine filaments and then cutting them to a desired length. The flocking material may be chopped fibers. The flocking material may be or may include a nylon (PA=polyamide) although polyester (PBT) can also be used for the temperature range expected of a heating layer of a heated blanket.

The flocking material may have a thickness on the order of about 0.1 mm or more, 0.2 mm or more, 0.5 mm or more, 1 mm or more, 1.5 mm or more, 2 mm, or more. The thermal conductivity of the flocking material may be in the range of about of 0.03-0.06 w/m-k (watts per meter-kelvin). However, in some configurations, a flocking material having a thermal conductivity of less than 0.03 w/m-k or more than 0.06 w/m-k may be preferred to achieve the desired benefit of reducing hot spots. The thickness or thermal conductivity of the flocking may be varied across the heating layer, to compensate for differences in hot spots. That is, certain regions may require more insulation or flocking than others, in order to achieve the desired result of a generally uniform heat output. In some configurations, the insulation or flocking may be reduced after assembly, for example, in cold spot regions, to allow the cold spot region to generate more heat to achieve a generally uniform heat output across the entire surface of the heating blanket.

The insulating substrate 37 and/or the one or more insulating mask regions 39 may be directly applied to the heating layer 28 and/or to the heating elements 42. For example, a fastener like an adhesive, glue, or paste may be applied directly onto the regions of interest (i.e., the heating layer 28; the heating elements 42) and the flocking material or insulating substrate 37 and/or the one or more insulating mask regions 39 may then be applied onto the adhesive or glue pattern. The adhesive may be screen printed onto the heating layer 28 and/or heating elements 42, and/or conductors. In other configurations, the fastener may also be or instead be pins, buttons, clasps, welds, stiches, hook and loop fasteners, pastes, screws, zippers, tape, etc.)

In some configurations, the insulating substrate 37 and/or the insulating mask regions 39 may be applied to one or both of the cover layers 26, 32. For example, the insulating substrate and/or the one or more insulating mask regions 39 may be attached via a suitable fastener (i.e., pins, buttons, clasps, welds, heat weld, bonding, heat bonding, stiches, hook and loop fasteners, adhesives, pastes, screws, zippers, tape, etc.) to the inside surface of the cover layer 26, 32 facing the heating layer 28. Additionally, or alternatively, the substrate and/or the one or more insulating mask regions 39 may be attached to an outer surface of the cover layers 26, 32, which opposes the inner surface facing the heating layer 28.

The insulating layer or substrate, or mask regions may be bonded directly to the heating and/or sensing conductors. The insulating layer or substrate, or mask regions may at least partially, but preferably completely cover the one or more heating and/or sensing conductors. By covering the one or more heating and/or sensing conductors, the insulating layer, substrate, or mask regions may prevent adjacent conductors from contacting one another and electrically shorting the system, if or when the heating blanket or heating layer is folded crinkled, or moved during use.

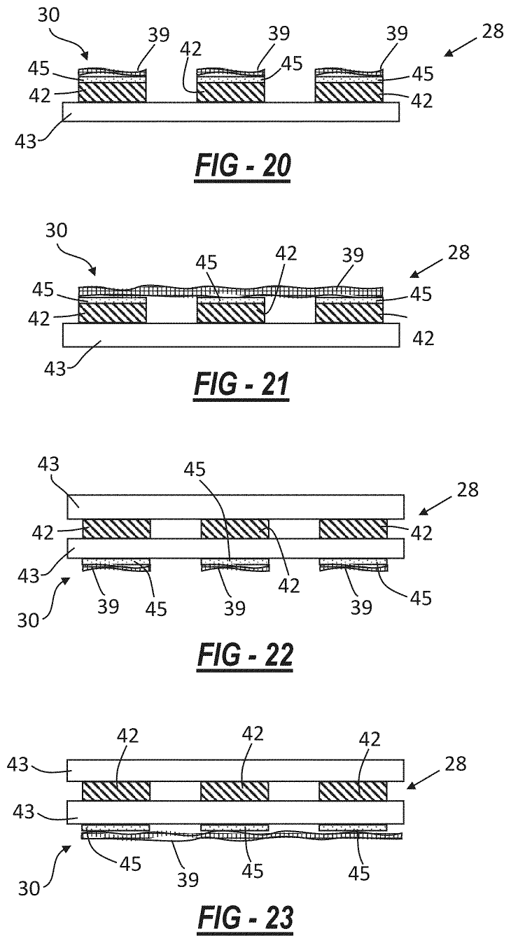

FIG. 20 shows a cross section of the heating layer 28 and the insulating layer 30. The heating layer 28 comprises one or more heating elements 42 disposed on the substrate 43 of the heating layer 28. An adhesive 45 may be applied onto one or more of the heating elements 42. The insulating mask 39 may then be applied locally onto the adhesive 45 such that the mask 39 at least partially or entirely covers the heating elements 42. The insulating mask 39 may be flocking or fleece, applied only in the areas of the adhesive 45. Regions in between the heating elements 42 and/or adhesive 45 may be free of any insulating mask 39 or flocking or substrate 37. In certain configurations, only the substrate is located between some adjacent heating elements 42.

In the variant illustrated of FIG. 21, the insulating mask 39 may be continuous and also cover regions between the heating elements 42. The regions in between the heating elements 42 may be the insulating mask 39 material, or the insulating substrate 37, which has lower insulating properties than the mask 39, as discussed above. In some configurations, the insulating material provided in the regions between the heating elements 42 may be removed in a subsequent process. For example, insulating material in the regions in between the heating elements 42 may be removed by punching, cutting, die punching, laser cutting, manually tearing, etc. In such an embodiment, after the insulating material is removed, the result may look like FIG. 20.

In FIG. 22, the one or more heating elements 42 are disposed between two substrates 43. An adhesive 45 may be applied onto one or both of the substrates 43. The adhesive 45 may be applied discretely or locally in regions corresponding to where the heating elements 42 are located. The insulating mask 39 may then be applied onto the adhesive 45 such that the mask 39 covers the heating elements 42.

In the variant illustrated in FIG. 23, the insulating mask 39 or flocking be continuous and also cover regions between the heating elements 42. The regions in between the heating elements 42 may be the insulating mask 39 material, or the insulating substrate 37, which has lower insulating properties than the mask 39, as discussed above.

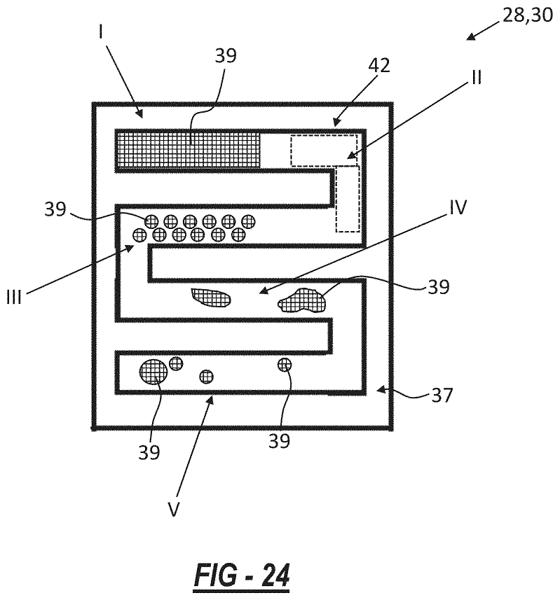

FIG. 24 illustrates a heating layer 28 covered by insulating layer 30, where the heating layer 28 is covered by different regions or types of insulation or insulating masks 39. For example, in region I, the insulating mask 39 covers substantially all of the heating element 42. In region II, there is no insulation mask 39 or insulating substrate material 37. In region III, the insulating mask 39 may be discretely applied in the region, having generally the same size and shape. In region IV, the insulating mask 39 may be randomly applied, with the areas having a generally unique or random shape. In region V, the insulating mask 39 may also be randomly applied, but the mask 39 may have generally the same shape and size. In other configurations, the sizes (and shape) of the insulating mask 39 may be different. By applying different masking 39 in different regions of the heating layer 28 where hot spots are detected, a uniform heating output of the heating layer 28 may be obtained. The localized hot spots may result from manufacturing differences, tolerances of the heating elements or conductors, etc. These localized hot spots may be reduced or lowered by applying the insulting mask 39 in those hot spot regions, according to these teachings. The hot spots may be detected at the heating layer manufacturing facility, after the heating layer 28 and/or blanket has been at least partially assembled, or in the field at the medical facility, for example.

The schematic illustration in FIG. 24 is intended to demonstrate that the size, shape, pattern, amount, and location of the insulating mask 39 may be applied onto the heating layer 28 in a customized or tuned manner, to compensate for local hot and cold spots, to achieve the result of having a generally uniform blanket surface temperature and to reduce hot spots. After the heating layer 28 is constructed, a test may be run to determine existence of any hot spots that may result from manufacturing variations, tolerances, etc., and a varying or specific amount of insulating mask 39 may be applied to that region. For example, in the areas where one or more hot spot are detected, insulation may be applied to the heating layer 28 to reduce the amount of heat conducted from that region. In areas where cold spots or generally uniform heating is observed, little or no insulation mask 39 may be applied (or in some instances insulation may be removed), to allow that region of the heating layer 28 to conduct more heat.

The testing for hot spots and the application of the insulation mask 39 may be completed in-line during the heating layer and/or heating blanket manufacturing and/or assembly process. For example, one or more tests may be performed on the heating layer to identify hot spots during manufacturing of the heating layer 28 and/or assembly of the blanket, and then a customized amount, type, and/or pattern of insulation mask 39 may be applied onto the heating layer 28. Accordingly, the application of the insulation mask 39 may be tuned or customized in-line, based on the heating performance of the heating layer 28. A subsequent test for hot spots may be performed after the application of the insulation mask 39 to ensure the hot spots have been reduced or removed. In the event hot spots still exist, additional insulation mask 39 may be applied onto the heating layer 28 in regions lacking mask 39 and/or over existing insulation mask 39. In some configurations, existing mask 39 may be removed and a new mask 39 may be applied.

The size, shape, and amount of insulation applied onto the heating layer 28 may be virtually any size, shape, and pattern. The shape of the insulation mask 39 may mirror the general size and shape of the hot spot region. For example, if the heating element 42 has a rectangular shape, then the insulation mask 39 may also have a rectangular shape. The same may be true for a circular shape, oval shape, etc. Moreover, the entire heating element 42 need not be covered by the insulation mask 39. For example, only a portion or a region of the heating element 42 may be covered by the mask 39, to still allow the heating element 42 to conduct a sufficient amount of heat. In some configurations, the entire heating element 42 may be covered by the mask 39. In some configurations, the entire heating element 42 may be covered by multiple masks 39. In other words, two or more different mask 39 materials, shapes, patterns, thermal properties, may be applied to the heating element 42 or layer 28.

In some configurations, the insulating mask 39 may be applied to regions adjacent to the one or more heating elements 42. In other words, the insulating mask 39 may be applied to regions of the heating layer 28 in between the heating elements 42 (i.e., over a region of the heating layer 28 where no heating elements 42 are arranged). Such an arrangement may be desirable to block or reduce heat conduction in a particular direction. For example, this may be desirable around the one or more plugs 24 to reduce interference or damage to the one or more plugs 24 that may be caused by excessive heat or hot spots from the heating elements 42.

In some configurations, a mask 39 having a certain shape, pattern, and/or thermal properties may be applied onto or over the heating elements 42 and another mask 39 having a different shape, pattern, and/or thermal properties may be applied onto the heating layer 28 in regions adjacent or proximal to the heating elements 42.

The shape of the insulation mask 39 may be square, circular, rectangular, diamond, triangular, and/or oval shaped. The insulation mask 39 may be randomly oriented on the heating layer or heating element. The insulation mask may be equally applied as a symmetrical pattern onto the heating layer or heating element.

The insulation mask 39 may be applied in layers, where one layer of insulation mask 39 is applied in certain regions of the heating element or heating layer and more than one layer of insulation mask 39 is applied in other regions that are determined to generate or conduct higher heat. In such configurations, an adhesive may be applied onto the layers of the insulation mask 39 to allow additional layers of the mask 39 to adhere thereto. In other configurations, a thicker application or stock of insulation mask may be applied without requiring additional layers of adhesive.

The insulation mask 39 may be arranged in strips that follow the general direction of the heating elements 42. The insulation mask 39 may be arranged in strips that run perpendicular or at another angle to the direction of the heating elements 42.

The insulation mask 39 may contain dots or droplets of material applied onto the heating element 42 or heating layer 28. The insulation mask 39 may be applied as a liquid and may then subsequently dry to a solid composition. The insulation mask 39 may be applied as a solid or dry composition.

These teachings provide a method of making a heating blanket 18. The method includes one or more steps. The method may include a step of performing a material removal operation on a first heating segment that includes a first electrically conductive foil on a first base layer. The portions of the first electrically conducive foil that remain on the first base layer form one or more first heating elements. The method may include a step of performing a material removal operation on a second heating segment that includes a second electrically conductive foil on a second base layer. The portions of the second electrically conducive foil that remain on the second base layer form one or more second heating elements. The method may include a step of electrically and physically connecting together the first heating segment and the second heating segment to form a heating layer of the heating blanket.

The method may include a step of locally adding an insulating layer to the one or more first heating elements and/or to the one or more second heating elements to reduce or eliminate hot spots on the heating layer. The method may include a step of applying an insulating layer across an entire or only a portion of the heating elements. The method may also include a step where after performing the material removal operation on the first heating segment and/or on the second heating segment, portions of the first electrically conductive foil that remain on the first base layer form one or more first sensing elements, and/or portions of the second electrically conducive foil that remain on the second base layer form one or more second sensing elements. The one or more first sensing elements may be configured to monitor or detect heat generated by the one or more second heating elements. The one or more first sensing elements may be configured to monitor or detect heat generated by the one or more first heating elements.

The material removal process may result in the one or more first heating elements being arranged in a first pattern, and the one or more second heating elements are arranged in a second pattern, wherein the two patterns are different. In some configurations, the two patterns may be the same.

The method may include a step of connecting together two or more heating segments (first heating segment and second heating segment) with one or more conductor strips. The one or more conductor strips may be a separate or discrete element from the first heating segment and/or the second heating segment. Alternatively, the one or more conductor strips may be a an integral part or element or extension of one or both of the first heating segment and/or the second heating segment.

The method may include a step of determining a heat output of the heating layer (or one or more of the heating segments) and identifying any hot spots. A hot spot may be a local region or area of the heating segment that has a higher temperature output than other regions. After the determining step, an insulating layer (i.e., flocking, or other insulator) may be applied onto the hot spot to reduce or eliminate an amount of heat that is generated or radiates from that local region. An adhesive may be applied between the insulating layer and the conductor or heating segment. Alternatively, the insulating layer or material may have an adhesive that can be used to stick or attach the insulation layer to the conductor or heating segment or heating element. After the insulating layer is applied to the heating segment, the method may include a step of rechecking the heating layer or segments for any remaining hot spots and repeating the step of applying the insulating layer to the heating segment or element. If any cold spots are detected (i.e., regions that are colder or cooler than other areas), any insulating layer in that region may be reduced or eliminated.

These teachings also provide a method. The method may include a step of determining a heat output of the heating layer. The method may include a step of determining hot or cold spots on the heating blanket, where a temperature output the heating layer is certain regions is above a certain threshold temperature or tolerance. The method may include a step of applying an insulation to the hot spots, to reduce or eliminate amount of heat conducted from the hot spot. The method may include a step of applying an adhesive to the hot spot before the step of applying the insulation. In some configurations, the insulation may already include the adhesive, or the adhesive may be applied to the insulation before applying the insulation to the hot spot. The insulation may be a flocking, fleece, or other material.

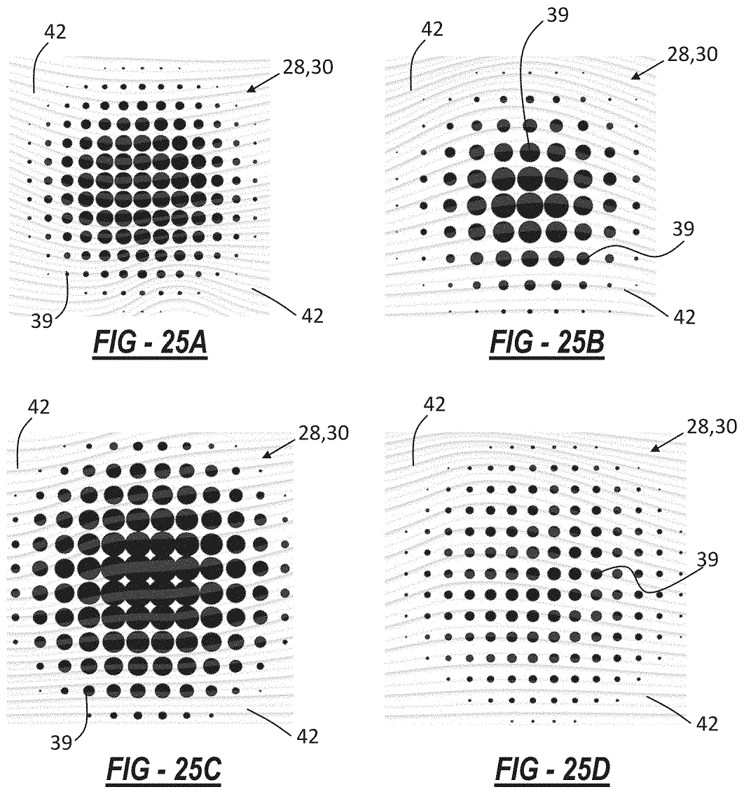

FIGS. 25A-25D illustrate a heating layer 28 covered by insulating layer 30, where the heating layer 28 is covered by different regions or types of insulation or insulating masks 39. For example, in each of the Figures, the insulation mask 39 has different sizes. In FIG. 25C, certain insulation masks 39 are in contact with one another or overlap, while the insulation mask 39 in the other figures are free of contact. In FIG. 25D, the spacing between adjacent masks 39 is generally the same, while the spacing between adjacent masks 39 in FIGS. 25A and 25B is different (i.e., the spacing becomes larger as the masks 39 decrease in size).

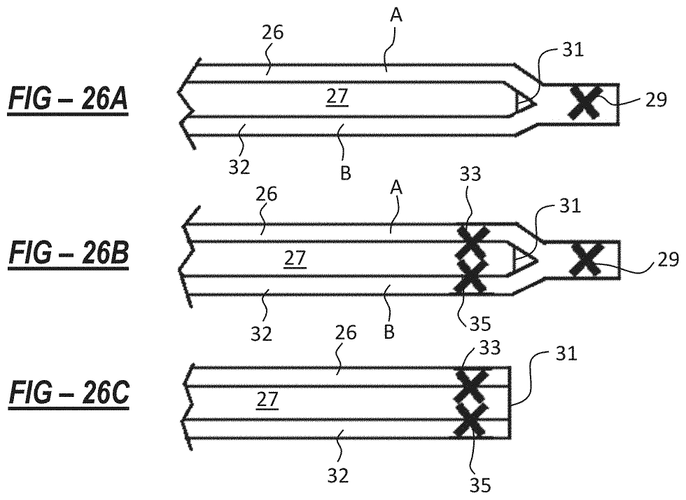

FIGS. 26A-26C illustrate exemplary methods of bonding or attaching together the various layers of the heating blanket 18.

In FIG. 26A, the first and second cover layers 26, 32 surround the internal layers 27 of the heating blanket 18. Internal layers 27 may include one or more of the heating layers, one or more of the insulating layers, one or more other layers, or a combination thereof. In FIG. 26A, the cover layers 26, 32 envelope or surround the internal layers 27. The surrounding layers 26, 32 may function to define a pouch or pocket for the internal layers 27 to be located inside thereof. The cover layers 26, 32 may be attached to one another about or around one or more of the edges 31 of the internal layers 27 at an attachment region 29. This may mean that the one or more internal layers 27 may be free to move relative to one another and/or inside of the pouch or pocket defined between or by the cover layers 26, 32. This may mean that a cap or space is defined between one or more edges of the internal layers 27 and the attachment region and/or the outer layers 26, 32. In other configurations, one or more fasteners may be provide to and/or through one or more of the cover layers 26, 32 and one or more of the internal layers 27 to restrict or prevent relative movement therebetween. For example, a double side tape, hook and loop fastener, heat stake, weld, stich, button, paste, adhesive, or the like may be utilized to attach one or more of the internal layers 27 to one another and/or to one or more of the cover layers 26, 32. Similarly, the attachment region 29 may include one or more welds, ultrasonic welds, RF welds, adhesives, rivets, stiches, tapes, glues, hook and loop fasteners, zippers, snaps, buttons and corresponding openings, laces, heat staking, or a combination thereof. In some configurations, it is not required that the attachment region 29 provide a hermetic seal within the pouch or pocket where the internal layers 27 are arranged. In this regard, one or more openings may be provided at the attachment region 29 or adjacent thereto that may provide for air to enter and/or leave the pouch or pocket or the region between the cover layers 26, 32.

However, in certain other configurations, it may be desirable to have a hermetic seal at the attachment region 29 to restrict or prevent air, liquids from entering and/or leaving the pouch or opening where the one or more internal layers 27 are arranged.

As used herein, about the edges 31 of the internal layers 27 means that the perimeter edges of one or more layers of the internal layers 27 are free from being attached to one or more of the cover layers 26, 32, the attachment region 29 or both. The edges 31 may be one or more long edges of the one or more internal layers 27, one or more short edges of the internal layers 27, or both. In such a configuration, one or more of the internal layers may be free from any attachment to one or both of the cover layers 26, 32 and/or attachment region 29. In such a configuration, the upper and lower cover layers 26, 32 may allow for one or more of the internal layers 27 to move within the pouch or pocket defined between the cover layers 26, 32. Alternatively, the cover layers 26, 32 may tightly surround one or more of the internal layers 27 and restrict or prevent any relative movement therebetween. The attachment region 29 may also be provided at the edges 31 of the internal layers 27 (but not in contact with the edges 31), which may also assist in developing a tight or form fitting pouch or pocket or enclosure about the internal layers 27 to substantially restrict or prevent any relative movement therebetween.

Additionally, or alternatively, one or more of the surfaces A, B of the of the internal layers 27 that face or are adjacent to one or more of the cover layers 26, 32 and/or one or more of the surfaces of the cover layers 26, 32 that face the surfaces of the internal layers 27 may have a friction surface (e.g., bumps, grooves, rough surface, etc.). that may function to restrict or prevent any relative sliding therebetween. This may advantageously prevent one or more of the internal layers from sliding or moving relative to the cover layers 26, 32. Additionally, or alternatively, one or more surfaces A, B or edges 31 of the internal layers 27 may include an adhesive or other attachment member (such as a weld, tack, stitch, tape, adhesive, rivet, etc.) for attaching or securing one or more of the internal layers to one or more of the cover layers 26, 32.

FIG. 26B illustrates another attachment method. In addition to the attachment region 29, that may be similar to that described above at FIG. 26A, the remarks of which apply to FIG. 261B, additional attachment regions 31, 33 are provided to attach one or more of the internal layers 27 to one or more of the cover layers 26, 32. It is understood, that the attachment method may include only attachment method 33, only attachment method 35, or both. Also, attachment method 33, 35 may be a single attachment method. The attachment method in regions 33, 35 may include one or more welds, ultrasonic welds, RF welds, adhesives, rivets, stiches, tapes, glues, hook and loop fasteners, zippers, snaps, buttons and corresponding openings, laces, heat staking, or a combination thereof.

One or both of the attachment methods 33, 35 may function to restrict or prevent relative movement between the one or more internal layers 27 of the heating blanket 18 and the one or more cover layers 26, 32. This may advantageously restrict or prevent folding or bunching of the internal layers 27, which may reduce or prevent hot spot, cold spots, during use.

FIG. 26C illustrates an attachment method that is similar to the remarks included above at FIG. 26B, which are incorporated by reference. In FIG. 26C, one or more edges 31 of the one or more internal layers 27 may be exposed (i.e., visible, or accessible from outside of the heating blanket 18). Alternatively, an additional layer or cover may be provided around the internal layers 27 to hide or conceal one or more edges 31 of one or more internal layers 27.

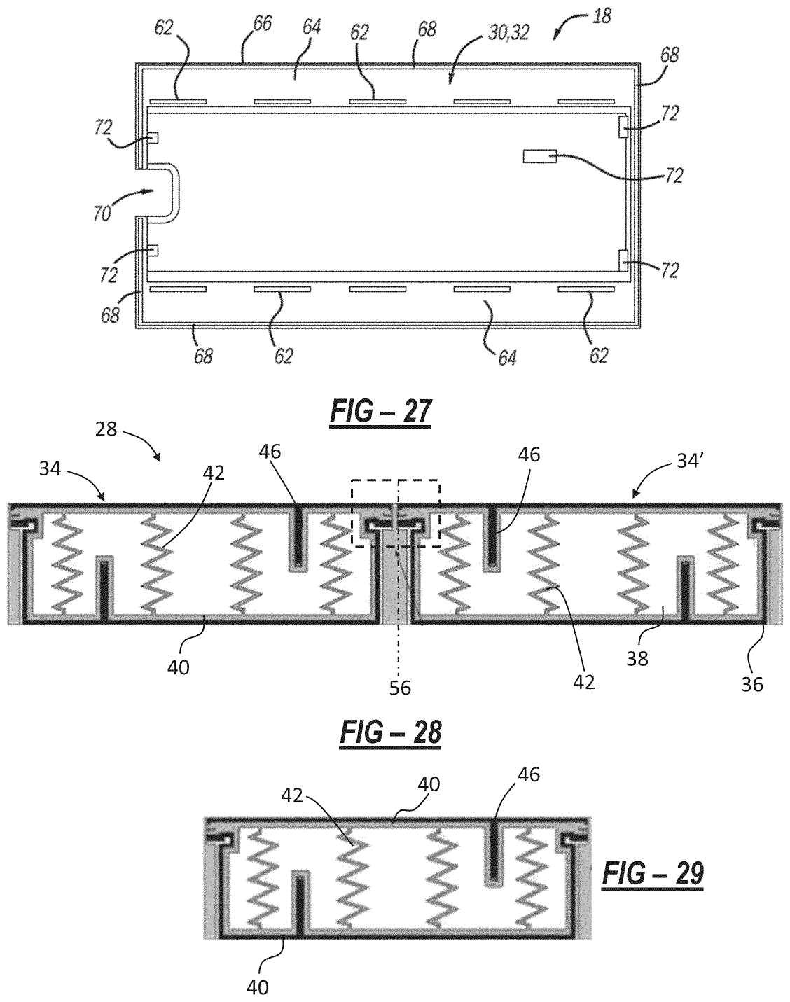

FIG. 27 illustrates a heating blanket 18. The blanket 18 includes a first attachment region 62. The first attachment region 62 may be located within or inside a periphery or edges of 66 of the blanket 18 (e.g., within the perimeter or outside or outer most edge of the blanket 18 or the cover layers 30, 32). The first attachment region 62 may join attach or connect together one or more layers of the blanket 18. For example, the first attachment region 62 may connect or join together the cover layers 26, 32. However, it is within the scope of this disclosure that the first attachment region 62 may also connect together one or more of the other layers 28, 30 of the blanket 18.

The first attachment region 62 may surround the entire perimeter of the heating layer 28 so that the heating layer 28 is contained within a pouch or envelope defined by the cover layers 30, 32 within a boundary of the first attachment region 62. Alternatively, the first attachment region 62 may not extend around an entire perimeter of the heating layer 28; instead, the first attachment region 62 may be arranged adjacent one or more edges of the heating layer 28, two or more edges, three or more edges, etc. For example, in FIG. 27, the first attachment region 62 is illustrated adjacent two opposing edges of the heating layer 28.

The first attachment region 62 may be formed with suitable attachment or connection elements, such as welding stitching, adhesives, clamps, pins, hook and loop fasteners, snaps, buttons, clasps, tape, and the like. The first attachment region 62 may be a continuous region. This means that there are no gaps, spaces, or absence of attachment material in the first attachment region 62. Alternatively, the first attachment region 62 may be intermittent—this means there may be spaces, gaps, or absence of attachment material in the first attachment region 62. For example, if the first attachment region 62 comprises welding (e.g., ultrasonic, RF, etc.), then there may be gaps, spaces, or absence of weld material adjacent to sections that include the weld material. Alternatively, if the first attachment region 62 is continuous and comprises welding, then there are no gaps, spaces, or absence of welding in the attachment region 62.

The heating blanket 18 may include one or more flaps 64. The one or more flaps 64 may be regions of the blanket 18 between the first attachment region 62 and an outermost edge 66 of the blanket 18, the one or more layers, the one or more cover layers 30, 32, or a combination thereof. The one or more flaps 64 may be arranged along the long edges of the blanket 18, the short edges of the blanket 18, or both. One or more of the long edges and/or short edges may be free of a flap 64.

The one or more flaps 64 may be free of any middle layers, except for one or both of the cover layers 30, 32. Alternatively, the one or more flaps 64 may also include one or more of the middle layers (i.e., heating layer 28, insulation layers 30, or both.) The one or more flaps 64 may be used to secure the blanket 18 to a bed, stretcher, floor, around a patient, or a combination thereof. For example, the one or more flaps 64 may be tucked under a patient or mattress or secured to a frame to prevent the blanket 18 from moving or falling off. The one or more flaps 64 may be cut off in a subsequent process before the blanket is used in the field. Alternatively, the one or more flaps 64 may remain on the blanket 18 during use.

The heating blanket 18 may include a second attachment region 68. The second attachment region 68 may join attach or connect together one or more layers of the blanket 18. For example, the second attachment region 68 may connect or join together the cover layers 30, 32. However, it is within the scope of this disclosure that the second attachment region 68 may also connect together one or more of the other layers 28,8, 30 of the blanket 18.

The second attachment region 68 may be located at or near the outermost edge or perimeter 66 of the layers and/or blanket 18. The second attachment region 68 may be arranged around an entire perimeter of the heating layer 28. The second attachment region 68 may not be arranged around an entire perimeter of the heating layer 28; instead, the second attachment region 68 may be arranged adjacent to one or more edges of the blanket 18. The blanket 18 may be free of the second attachment region 68 and/or the first attachment region 62 in a region 70 where the connector 24 connects to the blanket 18 and/or heating layer 28. By being free of the second attachment region 68 in this location (and also possibly free of the first attachment 62), access to the one or more inner layers or the heating layer 28 may be provided so that one or more connectors 24 and/or plugs can be connected to the heating layer 28.

The second attachment region 68 may be formed with suitable attachment or connection elements, such as welding stitching, adhesives, clamps, pins, hook and loop fasteners, snaps, buttons, clasps, tape, and the like. The second attachment region 68 may be a continuous region. This means that there are no gaps, spaces, or absence of attachment material in the second attachment region 68. The second attachment region 68 may be intermittent—this means there may be spaces, gaps, or absence of attachment material in the second attachment region 68. For example, if the second attachment region 68 comprises welding (e.g., ultrasonic, RF, etc.), then there may be gaps, spaces, or absence of weld material. Alternatively, if the second attachment region 68 is continuous and comprises welding, then there are no gaps, spaces, or absence of welding in the attachment region 68.

The heating blanket 18 may include a third attachment region 72. The third attachment region 72 may join, attach, or connect together one or more layers of the blanket 18. For example, the third attachment region 72 may connect or join together two or more of the inner layers of the blanket 18, like the one or more heating layers 28 and one or more insulating layers 30. For example, the third attachment region 72 may connect or join together one or more of the inner layers of the blanket 18, like the one or more heating layers 28 and one or more insulating layers 30 to one or more of the cover layers 30, 32. The third attachment region 72 may be a tape or adhesive that is between or sandwiched between two or more of the layers 26, 28, 30, 32 of the blanket 18. The third attachment region 72 may be a tape or adhesive that is provided around edges of two or more of the inside layers 28, 30 of the blanket 18, or both. The third attachment region 72 may be anywhere, including attaching the outer edges or perimeter of the layers. The third attachment region 72 may be anywhere, including on or between the faces or profiles of the layers, between the outer edges or perimeter. The third attachment region 72 may be formed with suitable attachment or fastening elements, such as welding stitching, adhesives, clamps, pins, hook and loop fasteners, snaps, buttons, clasps, tape, double sided tape, PSA, and the like.

FIG. 28 illustrates a heating layer 28 formed from two heating segments 34, 34′; however, the heating layer 28 may have any number of heating segments 34 (i.e., one or more heating segments). The heating segments 34, 34′ may be substantially the same, thus any reference to heating segment 34 may apply to heating segment 34′ and vice versa unless stated otherwise.

The heating segments 34, 34′ may be made in a single continuous method or process and may be connected together at a connecting region 56 to form a single, integral structure. The two heating segments 34, 34′ may be separated or disconnected at a connecting region 56 to provide two separate or independent segments 34, 34′. For example, referring to FIG. 29, the two heating segments 34 are separated along the connecting region 56 to have a single heating segment 34. The single heating segment 34 includes conductor traces 40, heating elements 42, and sensing elements 46, allow which are further discussed below, so that the single heating segment 34 can be used as the heating layer 28 of the heating blanket 18. It is understood that the heating layer 28 may be made of one or more of these segments. For example, a small heating layer 28 or blanket 18 may be constructed from a single segment, or large or long heating layer 28 or blanket 18 may be constructed from plural heating segments (e.g., two or more segments, four or more segments, ten or more segments, etc.). Advantageously, a heating layer 28 or blanket 18 can be constructed having virtually any size depending on how many segments 34 are used.

The two heating segments 34, 34′ may have the same or different pattern or arrangement of heating elements 42, conductor traces 40, sensing elements 46, or a combination thereof. For example, referring from left to right, the heating segment 34 comprises a heating element 42, a sensing element 46, two heating elements 42, a sensing element 46, and a heating element. The heating segment 34′ may have the heating elements 42 and/or sensing elements 46 arranged in the same of different order. The heating segment 34′ may have the sensing elements 46 arranged from different edges or sections of the heating segment 34′ compared to the heating segment 34.

A heating segment 34 may include one or more of the following layers: a carrier or base layer 36 and a foil layer 38. In some configurations, the base layer 36 and the foil layer 38 may be a single, integrated layer. In other configurations, the foil layer 38 may be separate from the base layer 36 but subsequently arranged, supported, attached, secured, or connected to the base layer 36.

The base layer 36 may be made of a suitable material, such as polyurethane, polypropylene, polymethylene, polyethylene terephthalate (PET), Polyimide (PI), or the like. The base layer 36 may be electrically conductive or electrically non-conductive. The base layer 36 may be more rigid than the foil layer 38 or vice versa. The base layer 36 may stabilize or support the foil layer 38.

The foil layer 38 may comprise a suitable electrically conductive material, such as metal, copper, aluminum, nickel, copper clad aluminum, the like, or a combination thereof. The foil layer 38 may comprise one or more conductor paths or traces 40. By selecting a suitable material for the foil layer 38 and/or a suitable size or shape of the conductor paths or traces 40 (i.e., width, thickness, height, length, shape, material, etc.), the foil layer 38 and/or the one or more conductor paths or traces 40 may be or may comprise one or more electrical heating elements 42, one or more sensing elements 46, or both. In other configurations, one or more heating elements 42 and/or sensing elements 46 may be attached or connected to the one or more conductor paths or traces 40 via a suitable fastener, electrical connector, and/or adhesive, such as for example conductive adhesive or soldering. The one or more conductor paths or traces 40 may function to conduct or carry electrical energy and/or electrical communication signals between the heating blanket, heating segments, the controller, power source, or a combination thereof. In certain other configurations, it is envisioned that electrical power and/or electrical communication signals may be wirelessly communicated or transmitted.

The one or more conductors or traces 40 or heating elements 42 may generate heat in response to electrical power or signals that are supplied to the heating segment. The one or more conductors or traces 40 or heating elements 42 may be one or more resistors. The one or more conductors or traces 40 or heating elements 42 may be one or more wire conductors attached, place, or integrated into the base layer, foil layer, or both. The one or more conductors or traces 40 or heating elements 42 may any other suitable heater that is configured to suitably perform one or more of the heating functions. The heating layer may comprise any of the heating elements disclosed herein.

The one or more sensing elements 46 may be configured to determine, sense, and/or monitor a temperature or heat generated by the heating layer and/or the one or more heating elements 42. The one or more sensing elements 46 may be one or more thermistors. The one or more sensing elements 46 may be one or more NTC thermistors (Negative Temperature Coefficient sensor). An NTC thermistor may be a non-linear resistor, which may alter its resistance characteristics with temperature. The resistance of NTC thermistor will decrease as the temperature generated by the heating elements 42 and/or sensed by the sensing elements 46. The one or more sensing elements 46 may be any other suitable sensor that is configured to suitably perform one or more of the sensing functions.

In some configurations, the foil layer 38 may be placed on the base layer 36 and subjected to an operation where certain portions of the foil layer 38 are removed, while other portions of the foil layer 38 remain on the base layer 36. The operation may be a milling, grinding, etching, or other material removal operation. The portions of the foil layer 38 remaining on the base layer 36 after the operation may be the electrically conductive traces or conductor paths 40, one or more electrical heating elements 42, one or more sensing elements 46, or a combination thereof. Accordingly, the one or more electrically conductive traces or conductor paths 40, one or more electrical heating elements 42, one or more sensing elements 46, or a combination thereof may be integrally formed on the foil layer 38. In the event that the foil layer 38 and the base layer 36 are formed as a single, integral layer, then the one or more electrically conductive traces or conductor paths 40, one or more electrical heating elements 42, one or more sensing elements or temperature sensors 46, or a combination thereof may be integrally formed on the base layer 36 after the material removal operation. Additionally, or alternatively, one or more heating elements 42, conductive traces or conductor paths 40, and/or sensing elements 46 may be subsequently attached or connected to the traces or conductor paths 40 or the remaining portions of the foil layer 38 after the material removal operation.

In some configurations, only the foil layer undergoes the milling, cutting, or material removal operation. The remaining portions of the foil (i.e., heating and/or sensing elements or conductors) can then be applied onto the base layer and connected or attached thereto using any fastening method described herein.

Additionally, or alternatively, the foil layer 38 and/or the remaining portions of the foil layer 38 may be covered with a suitable material, cladding, and/or surface treatment to allow attachment or connecting of one or more heating elements 42, one or more electrical conductors 44, one or more sensing elements 46, or a combination thereof to the foil layer 38. This may be advantageous when the foil layer 38 is made of a material that is or includes aluminum. Because aluminum or other similar materials may oxidize on their surface that may inhibit or prevent solder or other attaching mechanism from bonding to it, a need may exist for a cladding (e.g., copper or like materials) and/or a surface treatment to be applied to the foil layer 38 before electrical components like heating elements 42, sensing elements 46, conductors 44, and/or the like can be attached thereto. An example of a surface treatment that may be applied to the aluminum and/or foil layer 38 is MINA, developed by AVERATEK.

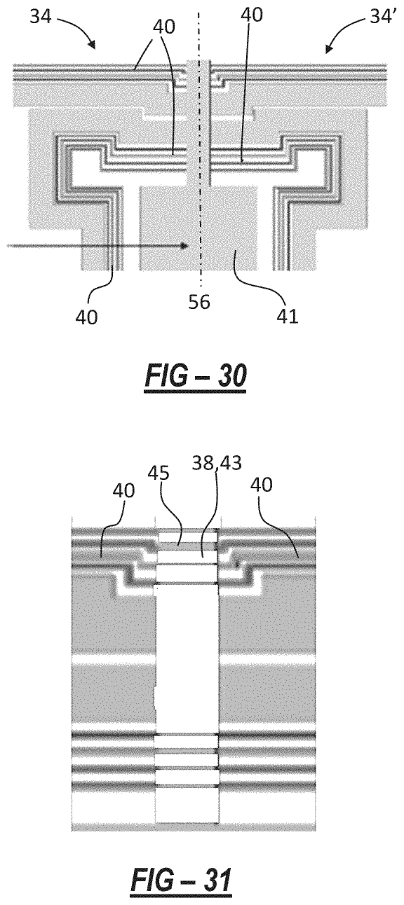

FIG. 30 illustrates a detail of the region in the dashed box of FIG. 28. A conductor layer 41 or strip is arranged between the two segments 34, 34′. With additional reference to FIG. 31, when it is desired for a heating layer 28 to comprise two or more heating segments 34, 34′ in order for the electrical power and/or communication signals to be conducted or communicated between the two or more segments 34, 34′ and the controller or power source (FIG. 1), certain regions 43 of the conductor layer 41 or strip or foil layer 38 are removed using the same or similar operation or method described above where certain portions of the foil layer 38 are removed, while other portions of the foil layer 38 remain on the base layer 36 to form the conductors v and/or heating elements 42. This operation to remove the regions 43 may take place before, during, or after the regions of the foil layer 38 are removed to form the conductors 40. After the regions 43 of the foil layer 38 are removed, the remaining parts of the foil layer 38 between the two segments 34, 34′ form conductors 45 to bridge or connect together conductors 40 in both segments 34, 34′. Accordingly, electrical power and/or communication signals to be conducted or communicated between the two or more segments 34, 34′ and the controller or power source (FIG. 1).

An overlay may be placed over the foil layer 36, the base layer 36, or both. The overlay may function to protect the foil layer 38, the conductor paths or traces 40, any elements attached to the foil layer 38 and/or traces 40, or a combination thereof. For example, the overlay may protect the foil layer 38 and/or heating segment 34 from electrical shorting or other damage, for example if a liquid or other contaminants penetrates the cover layer(s) and/or enters the blanket. For example, the overlay may comprise a polyethylene terephthalate (PET) that is attached to the foil layer 36, base layer 36, or both via an adhesive such as a pressure sensitive adhesive (PSA). The overlay may be a laminate.

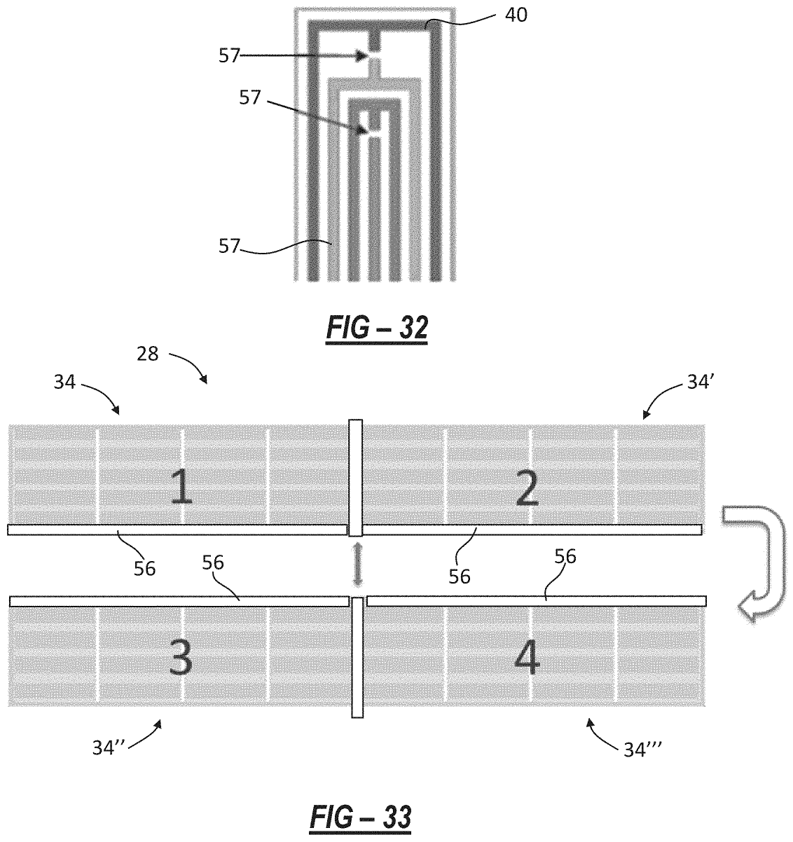

In FIG. 32, a processing operation of material removal similar to the ones described above can be used to break a connection between certain conductors 40 by adding or removing material in areas 57 of the conductor 40. This may function to disconnector or isolate certain regions of the heating segments from other (i.e., electrically disconnect certain heating elements and/or sending elements).

FIG. 33 illustrates a heating layer 28 formed of plural heating segments 34, 34′, 34″, and 34′. Heating segments 34, 34′ may be made of the same process as described above at FIGS. 28 and 31, and heating segments 34″, 34″ may be made of the same process as described above at FIGS. 28 and 31. The two groups of heating segments 34, 34′ and 34″, 34″ may then be joined together to form a heating layer 28 having a width that is about double in size. Virtually any number of heating segments may be joined together to construct a blanket 18 or heating layer 28 of any size. The two groups of heating segments 34, 34′ and 34″, 34′″ may be joined together at one or more edges or connecting regions 56, which may include one or more conductors or traces for physically and/or electrically connecting together the adjacent segments so electrical power and/or communication signals can be passed therebetween. The connecting region 56 may be a conductor strip, adhesive, tape, conductor, or the like. The conductor strip 56 may be a separate, discrete element that is used to join together two or more heating segments 34. Alternatively, the conductor strip 56 may be integrally formed with one or more both of the heating segments 34. The conductor strip 56 may be formed during the material removal process. In other words, a region of the conducive foil that remains on the base layer after the material removal process may be a conductor strip 56. The conductor strip may use tape or other fasteners (i.e., heat staking, sewing, stitching, etc.) to join together the adjacent heating segments 34, 34′. The conductor strip may be a flap or excess material of the first heating segment and/or the second heating segment. The conductor strip may overlap a top surface of the heating segments. The conductor strip may overlap a bottom surface of the heating segments. The conductor strip in some instances may be an insulator, and thus would be only a strip. The conductor strip may join together adjacent heating segments on their long edges and/or short edges.

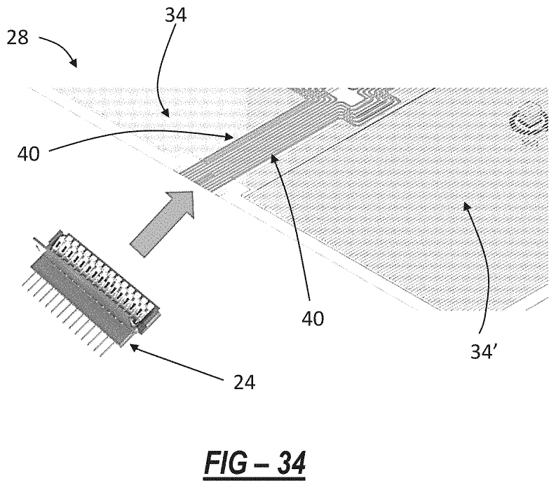

FIG. 34 illustrates a connector 24 installed at the edge of the heating layer 28. The heating layer comprises heating segment 34 and 34′. Conductors 40 from each segment 34, 34′ are arranged to begin at an edge region of the layer 28 so that a single connector 24 can be attached to the heating layer 28 an provide electrical signals and/or electrical power to and/or between both segments 34, 34′. The connector 24 can have resistors or coding resistors to identify resistance, heat generated, or both by the heating elements in different regions of the blanket 18, heating layer 28, or heating segments 34, 34′.

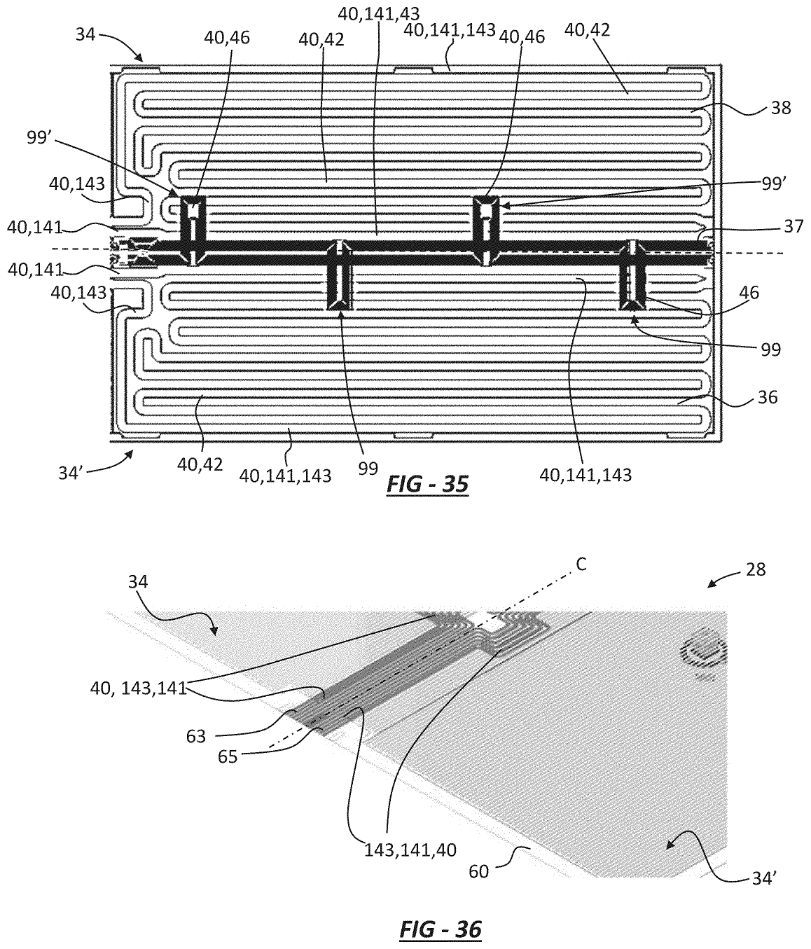

FIG. 35 illustrates two heating segments 34, 34′. The heating layer 28 may comprise only one heating segment 34, or may comprise two or more heating segments 34. The heating segments 34, 34′ are arranged adjacent to one another. However, the heating segments 34, 34′ may be formed as individual, discrete sections and then the individual, discrete sections may be brought together to form the heating layer 28. The two heating segments 34, 34′ are separated by the dashed horizontal line in FIG. 3.

The heating segments 34, 34′ may be the same. This means that the heating segments 34, 34′ may be made from the same manufacturing process and/or have the same or similar configuration and layout of elements. In other configurations, the two heating segments 34, 34′ may be different. For example, the two heating segments 34, 34′ may have substantially the same layers and components but arranged in a different pattern. For example, one or more of the heating elements, sensing elements, conductor traces, or a combination thereof may be provided in different areas on the segments 34, 34′ when compared to each other. While the following description refers to heating segment 34, it is understood the description also relates to segment 34′ unless otherwise stated.

A heating segment 34 may be a portion or layer of the heating layer 28 and/or of the blanket 18 that includes one or more sub layers. The one or more sub layers of the heating layer 28 may include one or more carrier or base layers 36 and/or one or more foil layers 38. In some configurations, the carrier or base layer 36 may be located below the foil layer 38 or above the foil layer 38. In some configurations, the foil layer 38 may be located above and below the carrier layer 36 such that the carrier layer 36 is sandwiched between the foil layers 38. In some configurations, the base layer 36 and the foil layer 38 may be a single, integrated layer. In other configurations, the foil layer 38 may be separate from the base layer 36 but subsequently arranged, supported, attached, secured, or connected to the base layer 36.

The base layer 36 may function to stabilize or provide a support structure or carrier for the foil layer 38 or other elements or layers of the heating layer 28. The base layer 36 may be made of a suitable material, such as polyurethane, polypropylene, polymethylene, polyethylene terephthalate (PET), Polyimide (PI), the like, or a combination thereof. The base layer 36 may be electrically conductive or electrically non-conductive. The base layer 36 may be an insulator. The base layer 36 may be more rigid or stiff than the foil layer 38, or vice versa.

The foil layer 38 may comprise a suitable electrically conductive material, such as metal, copper, aluminum, nickel, copper clad aluminum, the like, or a combination thereof. The foil layer 38 may comprise one or more conductor paths or traces 40. The one or more conductor paths or traces 40 may meander along the surface of the base layer 36. In some configurations, the traces 40 may extend generally diagonally, horizontal, horizontally, or may be irregularly located (not horizontal, vertical, or diagonal) on the base layer 36. By selecting a suitable material for the foil layer 38 and/or a suitable size or shape of the conductor paths or traces 40 (i.e., width, thickness, height, length, shape, material, etc.), the foil layer 38 and/or the one or more conductor paths or traces 40 may be, or may comprise, one or more electrical heating elements 42, one or more sensing elements 46, or both. In other configurations, one or more heating elements 42 and/or sensing elements 46 may be attached or connected to the one or more conductor paths or traces 40 via a suitable fastener, electrical connector, and/or adhesive, such as for example conductive adhesive or soldering. The one or more conductor paths or traces 40 may function to conduct or carry electrical energy or power and/or electrical communication signals between the heating blanket, heating segments, the controller, power source, or a combination thereof. In certain other configurations, it is envisioned that electrical power and/or electrical communication signals may be wirelessly communicated or transmitted between the elements of the heating system and/or heating blanket.

The one or more conductors or traces 40 and/or heating elements 42 may generate heat in response to electrical power or signals that are supplied to the heating segment. The one or more conductors or traces 40 or heating elements 42 may be one or more resistors heating resistors, wire heaters or resistors, or a combination thereof. The one or more conductors or traces 40 or heating elements 42 may be one or more wire conductors attached, place, or integrated into the base layer, foil layer, or both. The one or more conductors or traces 40 or heating elements 42 may any other suitable heater that is configured to suitably perform one or more of the heating functions. The heating layer may comprise any of the heating elements disclosed herein. The one or more heating elements 42 may be one or more PTC heaters.

The one or more conductors or traces 40 and/or sensing elements 46 may be configured to determine, sense, and/or monitor a temperature or heat generated by the heating layer and/or the one or more heating elements 42. The one or more sensing elements 46 may be one or more thermistors. The one or more sensing elements 46 may be one or more NTC thermistors (Negative Temperature Coefficient sensor). An NTC thermistor may be a non-linear resistor, which may alter its resistance characteristics with temperature. The resistance of NTC thermistor will decrease as the temperature generated by the heating elements 42 and/or sensed by the sensing elements 46. The one or more sensing elements 46 may be any other suitable sensor that is configured to suitably perform one or more of the sensing functions.

In some configurations, the foil layer 38 may be placed on the base layer 36 and/or connected thereto via one or more fasteners, or simply overlayed on the base layer 36. The foil layer 38 may then be subjected to an operation where certain portions of the foil layer 38 are removed from the base layer 38, while other portions of the foil layer 38 remain on the base layer 36. The operation may be a milling, grinding, etching, or other material removal operation. The portions of the foil layer 38 remaining on the base layer 36 after the operation may be the electrically conductive traces or conductor paths 40, one or more electrical heating elements 42, one or more sensing elements 46, or a combination thereof. Accordingly, the one or more electrically conductive traces or conductor paths 40, one or more electrical heating elements 42, one or more sensing elements 46, or a combination thereof may be integrally formed on the foil layer 38 and/or base layer 36. In the event that the foil layer 38 and the base layer 36 are formed as a single, integral layer, then the one or more electrically conductive traces or conductor paths 40, one or more electrical heating elements 42, one or more sensing elements or temperature sensors 46, or a combination thereof may be integrally formed on the base layer 36 after the material removal operation. Additionally, or alternatively, one or more heating elements 42, conductive traces or conductor paths 40, and/or sensing elements 46 may be subsequently attached or connected to the traces or conductor paths 40 or the remaining portions of the foil layer 38 after the material removal operation.

In some configurations, the foil layer 38 may be subjected to the aforementioned material cutting or removal operation to form the electrically conductive traces or conductor paths 40 and/or one or more electrical heating elements 42 before being installed or placed onto the base layer 36.

In some configurations, another foil layer 38′ may be subjected to another material removal operations to form the electrically conductive traces or conductor paths 40 sending elements 46. The another foil layer 38′ that includes the electrically conductive traces or conductor paths 40 sensing elements 46 may then be placed over and/or under the foil layer 38 which contains the electrically conductive traces or conductor paths 40 and/or one or more electrical heating elements 42. A laminate may then be placed over, under, and/or around the two layers to connect the two layers together. One or more of the electrically conductive traces or conductor paths 40 may be accessible through the laminate in order to attach one or more heaters and/or sensing elements thereto. In such a configuration, the one or more heating elements and/or sensing elements may be arranged above the laminating layer, while the one or more electrically conductive traces or conductor paths 40 are located below the laminate.

An outer laminating layer may be provided over, under, and/or around the base layer 36 and the foil layer 38 to connect, join, and/or maintain the position of the two layers 36, 38 together. The laminating layer may function to protect one or both of the layers 36, 38 from damage if liquid and/or solid contaminates enter the blanket 18 and/or penetrate one or more of the cover layers 26, 32 and/or insulating layers 30. The laminating layer may function to distribute heat generated by the heating layer 28 and/or the foil layer 38.

In some configurations, the foil layer 38 and/or the remaining portions of the foil layer 38 may be covered with a suitable material, cladding, and/or surface treatment to allow attachment or connecting of one or more heating elements 42, one or more electrical conductors 44, one or more sensing elements 46, or a combination thereof to the foil layer 38 and/or conductors 40. This may be advantageous when the foil layer 38 is made of a material that is or includes aluminum. Because aluminum or other similar materials may oxidize on their surface that may inhibit or prevent solder or other attaching mechanism from bonding to it, a need may exist for a cladding (e.g., copper or like materials) and/or a surface treatment to be applied to the foil layer 38 before electrical components like heating elements 42, sensing elements 46, conductors 44, and/or the like can be attached thereto. An example of a surface treatment that may be applied to the aluminum and/or foil layer 38 is MINA, developed by AVERATEK.

An overlay may be placed over the foil layer 36, the base layer 36, or both. The overlay may function to protect the foil layer 38, the conductor paths or traces 40, any elements attached to the foil layer 38 and/or traces 40, or a combination thereof. For example, the overlay may protect the foil layer 38 and/or heating segment 34 from electrical shorting or other damage, for example if a liquid or other contaminants penetrates the cover layer(s) and/or enters the blanket. For example, the overlay may comprise a polyethylene terephthalate (PET) that is attached to the foil layer 36, base layer 36, or both via an adhesive such as a pressure sensitive adhesive (PSA). The overlay may be a laminate.

The one or more conductor paths or traces 40 may be configured or enabled to electrically connect one or more of the heating elements 42, sensing elements 46, or both to the controller and/or power source (FIG. 1). The one or more conductor paths or traces 40 from each heating segment 34, 34′ may be electrically connected to a single connector 24, discussed herein.

The one or more conductor paths or traces 40 may also be separated into separate heating conductors 43 and sensing conductors 41. However, it is understood that the two conductors 43, 41 may be the same; a conductor 43, 41 may communicate signals and/or power between heating elements, sensing elements, controller, power source, or a combination thereof; a sensing conductor 41 may communicate with a heating element, a heating conductor 43 may communicate with a sensing element, or a combination thereof. Any reference made to conductor 40, 41, and 43 may apply to all conductors 40, 41, 43 and vice versa.

The one or more sensing conductors 41 may be separate, discrete conductors from the one or more heating segments 34, conductors 40, 43. The one or more sensing conductors 41 may be separate conductors that are placed over, below, or within the one or more heating segments 34. The one or more sensing conductors 41 may be part of or integrally formed on or with the one or more heating segments 34. The one or more sensing conductors 41 may have one or more sensing elements configured for monitoring or determining an amount of the heat generated by the one or more heating conductors (i.e., by a first heating conductor and/or a second heating conductor). The one or more sensing conductors 41 may be electrically connected to the single connector 24, discussed further below for communicating the one or more sensing signals to a controller, output, or monitor 12 (i.e., FIG. 1).

The heating segment 34 may comprise one or more fingers 99. The one or more fingers 99 may be integrally formed onto the structure of the heating segment 34. The one or more fingers 99 may be project or cantilever from an edge of a heating segment 34 and overlay an adjacent heating segment 34. For example, the one or more fingers 99 may extend from an edge of heating segment 34 and overlay heating segment 34′ to monitor or determine a temperature or heat output of the heating conductors associated with heating segment 34′. Similarly, the one or more fingers 99′ may extend from an edge of heating segment 34′ and overlay heating segment 34 to monitor or determine a temperature or heat output of the heating conductors associated with heating segment 34. A gap or absence of material may be defined between fingers 99. The fingers 99, 99′ may be located on a top surface of the corresponding heating segment 34, 34′ or on a bottom side of the heating segment 34, 34′. In some configurations, the fingers 99, 99′ may alternate between top and bottom sides of the corresponding heating segment 34, 34′. In other configurations some or all of the fingers 99 may be located on a top or bottom side of heating segment 34′, and some or all of the fingers 99′ are located on a top or bottom side of the heating segment 34. In some configurations, the fingers 99 may monitor or determine heat generated by heating segment 34, and fingers 99′ may monitor or determine heat generated by heating segment 34′.

The one or more fingers 99 may be a separate component that is overlayed or attached to the one or more heating segments 34. For example, the one or more fingers 99, 99′ may be connected via a central conductor 37 that extends along a length of the heating layer.

The one or more heating conductor 143, which may be the same as conductor 40 discussed above, may be configured, or enabled to conduct electrical power and/or signals between the one or more heating elements 42 and the controller and/or power source. Each heating conductor 143 may be connected to only one heating element 42, or more than one heating element 42. In some configurations, a heating conductor 143 may also connect to one or more sensing elements 46.

The one or more heating conductors 143 may be arranged at or along a periphery of the heating segments 34, 34′. That is, the one or more heating conductors 143 may be disposed or located at or along one or more of the perimeter edges (long and/or short edges of the segment) of the heating segment 34, 34′. For example, a first heating conductor 143 (one or more heating conductors 43) may be arranged along a top edge of the heating segment 34 and a second heating conductor 143 (one or more heating conductors 143) may be arranged along a bottom edge of the heating segment 34. Similarly, a third heating conductor 143 (one or more heating conductors 143) may be arranged along a top edge of the heating segment 34′ and a fourth heating conductor 143 (one or more heating conductors 43) may be arranged along a bottom edge of the heating segment 34′.

The one or more sensing conductors 141, which may be the same as conductor 40 discussed above, may be configured, or enabled to electrically connect one or more of the sensing elements 46 to the controller and/or power source (FIG. 1). The sensing conductors 141 may be configured or enabled to conduct electrical power and/or signals between the one or more sensing elements 46 and the controller and/or power source. In some configurations, a sensing conductor 141 may also connect to one or more heating elements 42.

The one or more sensing conductors 141 may be arranged at or along a periphery of the heating segments 34, 34′. That is, the one or more sensing conductors 141 may be disposed or located at or along one or more of the perimeter edges (long and/or short edges of the segment) of the heating segment 34, 34′. For example, a first sensing conductor 141 (one or more sensing conductors 41) may be arranged along a top edge of the heating segment 34 and a second sensing conductor 141′ (one or more sensing conductors 141′) may be arranged along a bottom edge of the heating segment 34. Similarly, a third sensing conductor 141 (one or more sensing conductors 141) may be arranged along a top edge of the heating segment 34′ and a fourth sensing conductor 141′ (one or more sensing conductors 141′) may be arranged along a bottom edge of the heating segment 34′.

In some configurations, the one or more heating conductors 143 and/or the one or more sensing conductors 141 may additionally, or instead, be arranged offset from or spaced apart from the edges of the heating segment 34, 34′. For example, one or more of the heating, sensing conductors 40, 141 may be arranged along a face of the heating segments, at or near a center longitudinal axis of the segment, or in a region anywhere between the edge perimeter of the segment and the center of the segment.

In some configurations, the one or more heating conductors 143 and the sensing conductors 141 may be combined such that a single conductor is enabled or configured to carry or conduct electrical energy and/or signals between one or more of the heating elements 42 and one or more of the sensing elements 46 and the power supply or controller. These combined conductors may likewise be located at the periphery or perimeter edges of the segment 34, 34′ or anywhere between the periphery or perimeter edges of the segment 34, 34′ and the center of the segment.

FIG. 36 illustrates two heating segments 34, 34′ joined together to form the heating layer 28, or a portion of the heating layer 28 if one or more additional heating segments are added to enlarge the size of the heating layer 28. In this configuration, one or more of the conductors 40 (i.e., heating conductors 143 and one or more of the sensing conductors 141) that were arranged at the peripheral edges of the heating segments 34, 34′ in FIG. 35 are located at longitudinal center C of the heating layer 28. Certain other conductors 40, 141, 143 may be located at the periphery or edges of the heating layer 28, for example, those that are located at the top edge of the segment 34 and the bottom edge of the segment 34 in FIG. 35.

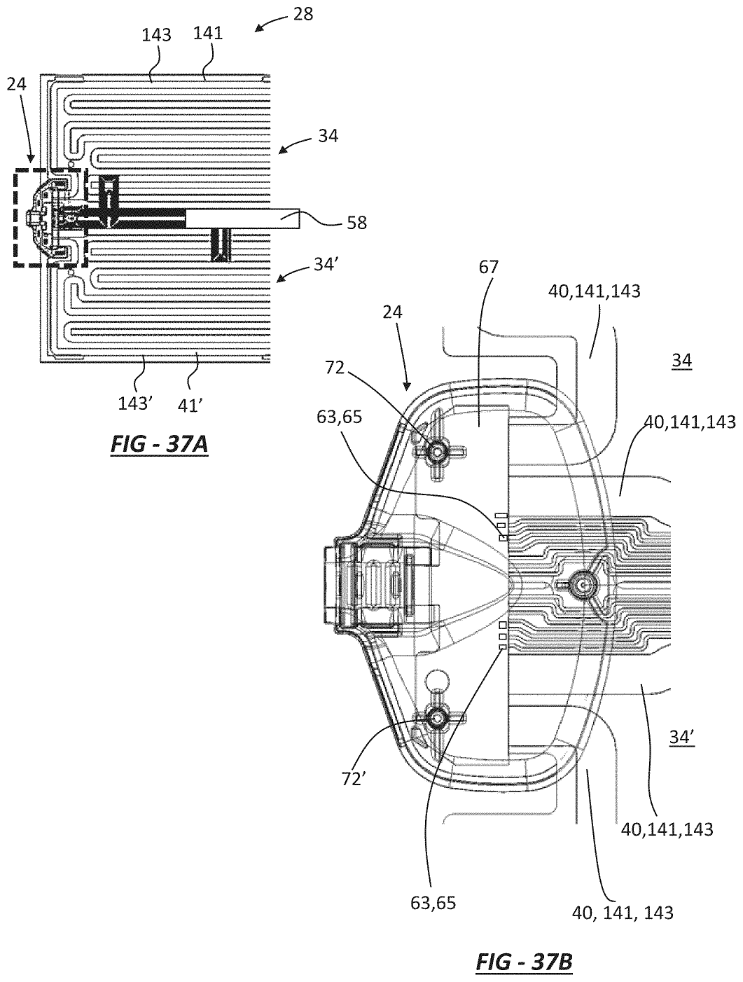

With additional reference to FIGS. 37A and 37B, one or more of the heating conductors 143 may have a respective heating terminal 63 and one or more of the sensing conductors 141 may have a respective sensing terminal 65. That is, the first heating conductor 143 may have a first heating terminal 63, the second heating conductor 143 may have a second heating terminal 63, the third heating conductor 143 may have a third heating terminal 63, and the fourth heating conductor 143 may have a fourth heating terminal 63. Similarly, the first sensing conductor 141 may have a first sensing terminal 65, the second sensing conductor 141 may have a second sensing terminal 65, the third sensing conductor 141 may have a sensing heating terminal 65, and the fourth sensing conductor 141 may have a fourth sensing terminal 65.

The aforementioned heating and sensor terminals may be part of a printed circuit board 67 or plug or connector 24, or may connect to the plug or connector 24 for connecting to the power source and/or controller (FIG. 1). The aforementioned heating and sensor terminals may be arranged proximate to each other at the edge 60 of the heating layer 28.

With continued reference to FIG. 37A, the heating layer 28 may optionally include a support 58. The support 58 may function to electrically connect the two heating segments 34, 34′. The support 58 may be an adhesive tape. The support 58 may be connected to one or more of the conductors 40, 143, and/or 141 on each segment 34, 34′. The support 58 may help maintain a connection between one or more of the conductors 40, 143, and/or 141 on the segment 34 with one or more of the conductors 40, 143 and/or 141 on the segment 34′. The support 58 may be electrically conductive and/or non-electrically conductive (an insulator). The support may be or may have an adhesive tape or layer. The support 58 may extend along all or a part of a longitudinal axis of the heating layer 28.

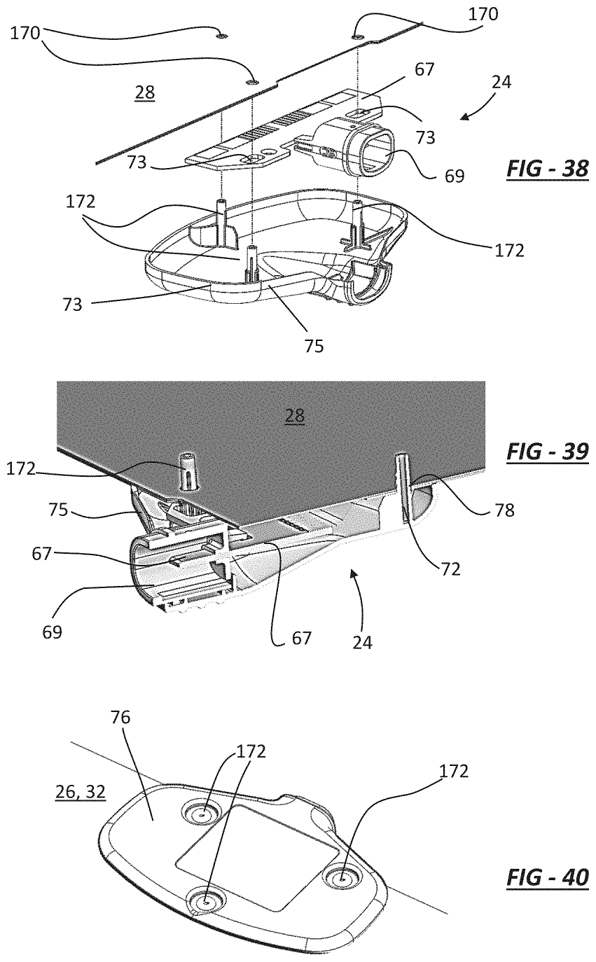

FIGS. 38, 39, and 40 illustrate a connector 24 and the heating layer 28. The connector 24 may comprise one or more printed circuit boards (PCB) 67. The PCB 67 may comprise one or more conductors or terminals (discussed further below) for connecting to one or more of the terminals 63, 65 discussed above, and/or for connecting to the conductors 40, heating conductors 143, and/or sensing conductors 141 of the heating layer and/or heating segments. The PCB 67 may be attached to the heating layer 28 with a suitable fastener, such as an adhesive, tape, weld, ultrasonic weld, RF weld, heat stake rivet, paste, or a combination thereof, or any of the other fasteners disclosed herein. The connector 24 may have a receptacle 69. The receptacle 69 may function to receive, hold, or maintain a connection with one or more of the plugs 14, 16 and/or connectors 20 thereof (FIG. 1). A portion of the PCB 67 or other connector may be contained or located within the receptacle 69 for connecting to one or more of the plugs 14, 16 and/or connectors 20 thereof.

The connector 24 may comprise a housing 71. The housing 71 may be made of one or more parts, such as a first part 75 and an opposing second part 76 (FIG. 40). The first part 75 may be located on a bottom side of the heating blanket and the second part 76 may be located on a top side of the heating blanket 18, or vice versa. The heating blanket 18 or layers thereof may be located or sandwiched between the parts 75, 76.

The first part 75 and/or the second part 76 may include one or more connections or attaching features 172 (three shown). One or more of the connections or attaching features 172 may be configured to extend through one or more PCB apertures 73 defined in the PCB 67 and/or one or more apertures 170 defined in the heating layer 28, cover layers 26, 32, insulating layers, or a combination thereof. The connections or attaching features 172 may be projections. The connections or attaching features 172 may be attached to the heating layer 28, cover layers 32, 26, one or more of the insulation layers, or a combination thereof via an adhesive, weld, RF weld, ultrasonic weld, fastener, glue, paste, rivet, stich, heat stake, or a combination thereof, or any of the other fasteners disclosed herein.

In FIG. 40, the connections or attaching features 172 are heat staked so that all inner layers are maintained between the two cover layers 26, 32 and between the two parts 75, 76 of the housing 71. In addition to the connections or attaching features 172, or instead of the connections or attaching features 172, the parts 75, 76 of the housing 71 may be attached to one another and/or to one or more of the blanket layers by other mechanisms, such as glue, adhesives, welding, bonding, screws, rivets, snaps, clips, projections, barbs, the like, or a combination thereof.

Referring back to FIG. 37B, the single connector 24 is connected to the first heating segment 34 with a first connection or attaching feature 172 and to the second heating segment 34′ with a second connection or attaching feature 172′. The connector 24 may be connected to the heating segments 34, 34′ with two or more connection or attaching features.

FIG. 41 illustrates the printed circuit board (PCB) 67. The PCB 67 may comprise one or more conductors or terminals 79, 77 for connecting to one or more of the heating layer 28 terminals 63, 65 discussed above, connecting to the conductors or traces, 40, heating conductors 143, the one or more sensing conductors 141, or a combination thereof. For example, the one or more outer terminals 79 may be power conductors for supplying one or more of the heaters, heating traces or heating conductors, temperature sensors, sensing elements, sensing conductors, or a combination thereof with electrical energy. For example, the one or more inner terminals 77 may be power conductors for supplying one or more of the heaters, heating traces or heating conductors, temperature sensors, sensing elements, sensing conductors, or a combination thereof with electrical energy. For example, the one or more outer terminals 79 and/or inner terminals 77 may be signal conductors for supplying, transferring, or conducting one or more electrical signals between the PCB 67 and components of the heating layer and/or blanket. The one or more conductors or terminals 79, 77 may be directly connected to the one or more terminals 63, 65 discussed above, connecting to the conductors 40, heating conductors 143, and/or sensing conductors 141 or connected thereto via one or more other conductors, terminals, or traces.

FIG. 42 illustrates the PCT 67 connected to the heating layer 28. The one or more projections 73 (two shown) extending from the housing 75 (and/or may extend from housing 76, FIG. 40) extend through corresponding PCB apertures 173 defined in the PCB 67. One or more other projections 172 (one shown) extending from the housing 75 (and/or may extend from housing 76, FIG. 40) extends through a heating layer aperture 170 defined in the heating layer 28. This heating layer aperture 170 may be pre-formed prior to the projection 172 passing therethrough, or the aperture 170 may be formed by puncturing the heating layer 28 with the projection 172. Any of the projections 172 disclosed herein may be replaced by or pins, screws, rivets, push pins, and/or other fasteners or adhesives.

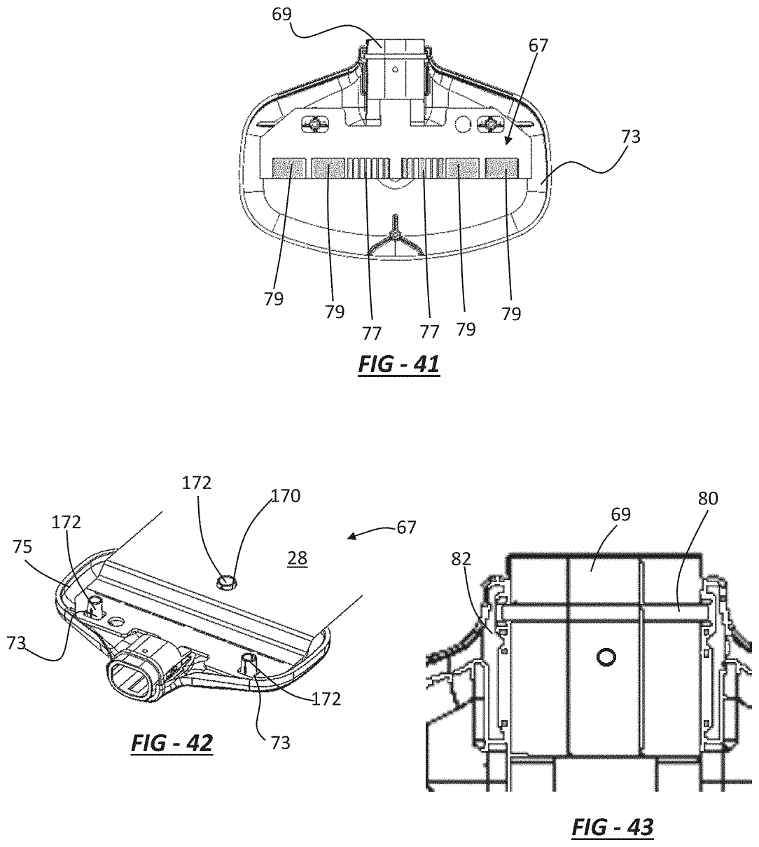

FIG. 43 is a close up of a portion of FIG. 42. The receptacle 69 may have one or more flanges or other retaining members 80 that are configured to be received into a receiving channel 82 for maintaining the position of the receptacle 69 and/or PCB 67 relative to the housing 71, 75, 76.

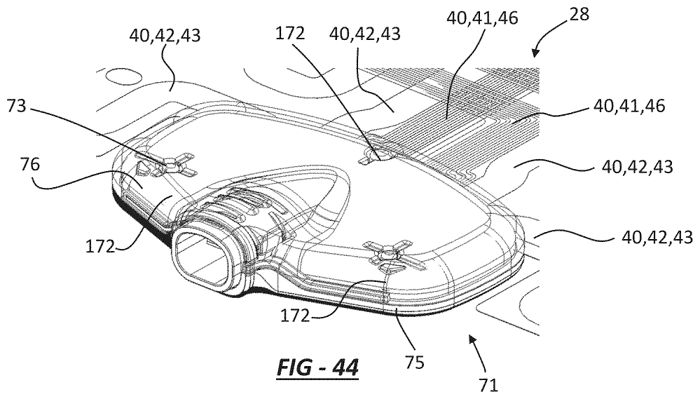

FIG. 44 illustrates the assembled housing 71 that includes parts 75 and 76 about the heating layer 28. The insulating layers and the cover layers are not shown in this figure for clarity.

The projections 172 extend through corresponding apertures 73 in the PCB and apertures 170 in the heating layer 28. The rear or inboard projection 172 extends through the heating layer 28 such that the traces or conductors 40, sensing conductors 141, sensing elements 46 meander around the projection 172. Also, the conductors 40, heating elements 42, and/or heating conductors 143 extend adjacent to the projection 172 to an edge region of the heating layer 28 to connect to the PCB 67.

The following paragraphs provide additional disclosure regarding the heating system, the method of making the heating system and/or heating blanket, the heating blanket, and one or more layers or elements of the heating blankets. All disclosure relating to any element may be combined, omitted, duplicated, omitted, or modified by any teaching herein to form a heating system, blanket, and/or method of manufacturing of the same.

The heating system may include one or more heating blankets. A heating blanket may be enabled or configured to generate heat. A heating blanket may include one or more layers and/or elements that are enabled or configured to convert electrical energy into heat energy to generate heat. The electrical energy may be supplied from a power source, controller, or both. The electrical energy may come from an AC power source, a DC power source, or both.

A heating blanket may be placed over, under, or around a patient, user, animal, object, etc. to increase or maintain a temperature of the user, animal, object, etc. and/or increase air surrounding the user, animal, object, etc. For example, a heating blanket may be used to cover a user, animal, or object from a top side. A heating blanket may be used to wrap a user, patient, animal, or object so the top, bottom and sides of the user, animal, or object are covered. A heating blanket may be used to support a user, patient, animal, or object from a bottom side (e.g., the heating blanket may be a pad or mattress or a mattress cover). A heating blanket may be used cover or wrap only a portion of a user or patient, such as an arm, leg, torso, head, etc. A heating blanket may be used in medical and/or non-medical procedures.

A heating blanket (and/or one or more layers of the heating blanket) may have any shape. For example, the heating blanket and/or one or more of the layers thereof, may have a generally rectangular shape, a square shape, circular or round shape, oblong or oval shape, etc.

A heating blanket (and/or one or more layers of the heating blanket) may be radiolucent or at least generally transparent, to X-rays so a patient can be warmed during a medical procedure.

A heating blanket may include one or more layers. The one or more layers may include a top or first cover layer, a heating layer, an insulating layer, and a bottom or second cover layer. One or more of these layers may be duplicated and/or eliminated. One or more of the layers may be divided into two or more layers. Two or more of these layers may be combined into a single layer. Any of the layers may be arranged in any order. Any of these layers may include one or more sub layers. For example, the heating layer may include a base or carrier layer and a foil or conductive layer.

A heating blanket and/or one or more layers of the heating blanket (e.g., heating layer) may include one or more plugs, ports, and/or connectors for connecting to one or more of the cables, controllers, power sources, or a combination thereof. The heating blanket and/or one or more layers of the blanket, may include one or more knobs, buttons, levers, switches, and/or keypads for turning the system ON and OFF, increase and/or decreasing a heat output from the heating blanket, increasing and/or decreasing a power supply to the heating blanket, monitoring the heating performance of the heating blanket, suppressing one or more alarms, or a combination thereof.

A heating blanket may include one or more layers. A heating blanket may include one or more heating layers. A heating layer may function to generate heat. A heating layer or one or more elements or components of the heating layer may function to convert electrical energy or power into heating energy or heat.

A heating layer or one or more of the other layers, may be flexible, stretchable, foldable, bendable, rollable, and/or foldable. The heating layer, or one or more of the other layers may be adapted to stretch into a 3-dimensional compound curve without wrinkling or folding while maintaining electrical conductivity, and subsequently return to the same generally planar shape. The heating layer may include one or more slits, slots, recesses, holes, or absence of material. The one or more slits, slots, recesses, holes, or absence of material may function to provide for the heating layer and/or blanket to bend, fold, and/or conform to a patient or object. The one or more slits, slots, recesses, holes, or absence of material may function to provide for one or more fasteners to puncture or extend through the heating layer to connect together two or more layers of the blanket.

The heating layer may be made of one or more layers or sub layers. The one or more layers of the heating layer may be a base or carrier layer and a foil or conductive layer.

A heating layer may include one or more base or carrier layers. A base or carrier layer may function to support the foil or conductive layer that is placed on top and/or on the bottom of the carrier layer. A foil or conductive layer may surround a base or carrier layer. A base or carrier layer may function to provide strength and/or rigidity to the heating layer.

A base or carrier layer may be made of a suitable material, such as polyurethane, polypropylene, polyeethylene, or the like. A base or carrier layer may be made of a conductive or non-conductive material. The base or carrier layer may be made of a woven or knitted material. The base or carrier layer, or any other layer of the heating blanket, may be made of a material that is flexible, stretchable, foldable, bendable, rollable, or the like. This may advantageously enable the heating layer, or any other layer of the blanket to be easily folded, rolled, crumbled.

A heating layer may include one or more foil or conductive layers. The conductive layer may function to convert electrical energy or power into heating energy or heat. The conductive layer may comprise one or more electrically conductive materials. For example, the conducive layer may be made of or comprise a material such as metal, copper, aluminum, nickel, silver, or the like.

The conductive layer may be supported on one or more carrier or base layers. The conductive layer may be supported on one side of the base layer (e.g., a top side). The conductive layer may be supported on both sides of the base layer (e.g., a top and bottom side).

The conductive layer may be placed, attached, connected, secured, welded, and/or printed onto the base layer. The conductive layer may be a foil, sheet, layer. The conductive layer may undergo one or more operations to remove certain portions of the conductive layer from the base layer. The portions of the conductive layer remaining on the base layer may be formed into one or more bus bars, conductive traces or conductive paths, heating elements, temperature sensors, or a combination thereof. The operation may provide for the remaining portions to have different thickness, widths, shapes, and/or contours to form the respective traces or conductive paths, heating elements, temperature sensors, or a combination thereof. The operation may include a milling, dry milling, grinding, stamping, shaping, or other material removal process. The operation may be free of any acid etching or acid removal or chemical solvent or copper etching or acid corrosion process, which may thus be more environmentally friendly. Alternatively, or additionally, the operation may be a printing operation, where the one or more bus bars, conductive traces or conductive paths, heating elements, temperature sensors, or a combination thereof are printed or applied onto the base layer.

The conductive layer may undergo one or more operations or processes to remove and/or prevent the formation of aluminum oxide on the conductive layer. This may optionally occur before or after any material removal operations. Such process may include nickel-palladium or nickel-silver plating. A surface treatment such as MINA developed by AVERATEK can be applied to the aluminum. The surface treatment may provide for the conductive layer or the remaining portion of the conductive layer after the material removal option to accept solder so that one or more elements like traces, conductors, heating elements, temperature sensors, or a combination thereof can be attached.

A heating segment may have one or more connecting regions. A connecting region may be a region or section of the heating segment that functions, allows, or permits one or more heating segments to be connected to another one or more heating segments. For example, a heating segment may comprise one or more conductors, conductive traces, conductive paths, heating elements, temperature sensors, or a combination thereof. By connecting together one or more connecting regions, electric power and/or communication signals may be conducted and/or communicated between and/or through the connecting heating segments. This allows multiple heating segments to be connected together and then controlled and/or monitored via the controller.

A connecting region may be located at one or more of the edges of the heating segment. A connecting region may be located at one or more outer edges or outer most perimeter. A connecting region may be located across a planar face of the heating segment. A connecting region may be formed by folding, bending, creasing, and/or manipulating a heating segment. Adjacent connecting regions may be connected together via one or more fasteners, adhesives, conductors, tapes, pastes, adhesives, or the like.

The heating layer, heating segment, and/or the conductive layer may include one or more heating elements. A heating element may function to generate heat in response to being supplied with electrical energy.

A heating element may have an operating voltage of between about 10 and 50 V or between about 12 and 24 V. A heating element heating element may have a power density of between about 10 and 500 W/m², between about 50 and 300 W/m², or between about 150 and 250 W/m A heating element may have a power output between about 10 and 500 W, between about 50 and 200 W, or between about 100 and 130 W. A heating element may have a resistance between about 1 and 10 Ohm or between about 2-6 Ohm.

A heating element may be an integral part of the conductive layer. That is, after the conductive layer undergoes a material removal process, the remaining sections of the conductive layer may include or be the one or more heating elements. Additionally, or alternatively, a heating element may be attached to the remaining sections of the conductive layer and/or the carrier layer via an attaching operation, such as printing, welding, soldering, etc.

A heating layer, heating segment, heating zone, or a combination thereof may include one or more heating elements. If a heating layer, segment, zone, or a combination thereof includes plural heating elements, the plural heating elements may be arranged electrically in series, electrically parallel to each other, or a combination thereof.

A heating element may be a resistor. A heating element may be a positive temperature coefficient (PTC) heater. A PTC heater may be a self-regulating heater. The heating element may be made of or comprise a material such as metal, copper, aluminum, nickel, silver, or the like.

The heating layer, heating segment, and/or the conductive layer may include one or more conductive traces or paths. A conductive trace or path may function to transfer or conduct electrical energy from the controller or power source to the one or more heating elements, sensing elements, or both. A conductive trace or path may function to transfer or conduct electrical communication signals between the controller or power source and the more heating elements, sensing elements, or both.

A conductive trace or path may be an integral part of the conductive layer. That is, after the conductive layer undergoes a material removal process, the remaining sections of the conductive layer may include or be the one or more conductive traces or paths. Additionally, or alternatively, a conductive trace or path may be attached to the remaining sections of the conductive layer and/or the carrier layer via an attaching operation, such as printing, welding, soldering, etc. The conductive trace or path may be made of or comprise a material such as metal, copper, aluminum, nickel, silver, or the like.

A conductor or trace may function to electrically connect together one or more controllers, heating segments, heating zones, heating elements, sensing elements, or a combination thereof. An electrical conductor or trace may include exactly one heating element and/or sensing element. An electrical conductor or trace may include plural heating elements and/or sensing elements. A heating segment may thus include one or more conductors or traces per each heating zone.

The electrical conductors or traces may be arranged anywhere on the heating layer, heating zone, heating segment, or a combination thereof. For example, one or more of the conductors or traces may be arranged along a center longitudinal axis of the heating layer, heating zone, heating segment, or a combination thereof. For example, one or more of the conductors or traces may be arranged in a region located above or below a center longitudinal axis of the heating layer, heating zone, heating segment, or a combination thereof. For example, one or more of the conductors or traces may be arranged along a bottom, top, or side edge of the heating layer, heating zone, heating segment, or a combination thereof. For example, one or more of the conductors or traces may be arranged along a planar face of the heating layer, heating zone, heating segment, or a combination thereof.

The heating blanket, heating layer, heating zone, heating segment, or a combination thereof may include one or more sensing elements. A sensing element may function to monitor, detect, and/or control one or more of the heating elements. Each heating zone and/or heating segment may include at least one sensing element to monitor and/or control the heating elements in that heating zone. A sensing element may have a NTC semiconductor. A sensing element may be a flat measuring resistor made of a material such as the heating element.

A sensing element may service as a safety sensor. As a safety sensor, the sensing element may decrease power supplied to the heating element or decrease a heating output if the temperature sensed is at or above a pre-determined level. This may advantageously function to reduce or prevent chances of excessive patient warming or patient burning. The sensing element, safety sensor, or both may be in electrical communication (wired and/or wireless) with an alarm that may be part of the controller or heating blanket to alert (via an audible and/or visual signal) to alert a user and/or operation of a fault, over heat condition, underheat condition, or a combination thereof.

The heating blanket may include one or more sensing elements per heating zone, per heating element, and/or per pair of heating elements.

The measuring and/or monitoring results of the sensing element may be only related to a part of heating layer, heating segment, heating zone, or a combination thereof. This may advantageously provide for the ability to monitor and understanding heating performance of each heating zone and/or heating element, which may be desirable to debug and locate hot spots (spots or areas with high or excessive heating temperatures) and/or cold spots (spots or areas with little or low heating temperature).

The sensing element may be electrically connected to the heating element, the controller, the power source, or a combination thereof. One or more sensing elements may be electrically connected to the heating element, the controller, the power source, or a combination thereof via one or more conductors or traces. Advantageously, by connecting a sensor element to the controller via a dedicated conductor, the controller may easily monitor the heating performance in a particular heating zone.

The heating layer may include one or more cover layers. The one or more cover layers may function to protect and/or conceal the other layers of the heating blanket. The one or more cover layers may function to reduce or minimize changes of the heating layer contacting or burning a user or patient. The one or more cover layers may function to restrict or prevent liquids from penetrating the heating blanket and contacting one or more of the other layers, like the heating layer. The one or more cover layers may protect a user or patient from electric shock hazards, burning due to excessive or elevated temperatures generated by the heating layer, or both.

The one or more cover layers may include a top layer, a bottom layer, or both. In some instances, the top and bottom cover layers may be formed from a single layer that wraps around the other layers of the heating blanket (e.g., the heating layer and/or the insulting layer). In other instances, the top and bottom cover layers may be discrete pieces that are connected together to form an envelope or bag structure, into which the other layers of the heating layer are located.

One or more of the layers may be connected together. For example, the front and back layers may be connected together; the heating layer may be connected to the insulating layer; the insulating layer may be connected to the top layer and/or the bottom layer; the heating layer may be connected to the top layer and/or bottom layer; or any other combination thereof. By connecting one or more of the layers together, it may advantageously reduce or prevent one or more of the layers from moving relative to each other. The one or more layers may be connected with an electrically conductive adhesive, weld, or fastener and/or a non-electrically conducive weld, adhesive, or fastener. For example, the one or more layers may be connected with a one or more rivets, stitching, grommets, hook and loop fasteners, staples, buttons, snaps, push pins, hot melt welding, welding, rf welding, adhesives, glues, and/or the like. Alternatively, one or more of the layers may be free of any connection to one or more other layers.

The top and bottom cover layers may be joined together to form a hermetically sealed heating blanket. This means that the region between the two cover layers is sealed such that air is unable to enter a region between the two cover layers and/or exit the region between the two cover layers. In other words, there is no or substantially no exchange or air between a region inside the cover layers and/or blanket and the surrounding environment.

Alternatively, the top and bottom cover layers may be joined together to form a non-hermetically sealed heating blanket. This means that air is able to enter a region between the two cover layers and/or exit the region between the two cover layers. In other words, there is an at least partial exchange or air between a region inside the cover layers and/or blanket and the surrounding environment. Air gaps, voids, or openings may be formed in one or both of the top and bottom cover layers. Voids or breaks in the welds or seals around a perimeter of the heating layer and/or cover layers may permit air to enter and/or exit the region inside the blanket. An opening may be defined in a part of the blanket to access the heating layer. This may allow the connector and/or PCB to be connected and/or disconnected from the heating layer. The connector may also be free of a hermetic seal. That is, an exchange of air may take place through the two parts of the housing of the connector and/or through a region where the PCB extends through the receptacle of the connector.

The cover layer may be made of a suitable material that restricts or prevent liquids (disinfectants, blood, etc.) from penetrating and/or being absorbed. For example, the cover layer may be made from a textile material, such as an impregnated or non-impregnated fleece. The cover layer may be made of a spunbond meltblown (SMS) polypropylene with an LDPE film coating. The cover layer may be made from a material comprising polypropylene, LDPE (polyethylene), PVC, urethane, or a combination thereof. The cover layer may comprise a nylon or woven nylon. The cover layer may be made of a material comprising of polypropylene, low-density polymethylene (LDPE) polypropylene, fleece, non-woven fleece, polymeric foam or film, a thermally insulating material, a high-loft fibrous non-woven material, foam, compressible foam, or a combination thereof. The cover layer may include a coating that repels liquids. The cover layer may comprise any of the materials disclosed herein. The cover layer may have a weight on the order of about 30 or more GSM (grams per square meter) or less than 30 GSM. Preferably, the cover layer may have a weight of about 32 GSM. The cover layer may be made of a composition of a nonwoven material and a cover material. The composition may have a weight on the order of about 3 or more GSM or less than 30 GSM. The nonwoven material may have a weight on the order of about 20 or more GSM or less than 20 GSM. The cover material on the nonwoven material (i.e., an LDEP film) may have a weight on the order of about 12 or more GSM or less than 12 GSM. The cover layer may have a tinsel strength of about 7.0 KG/IN (MD) or more or less, 5.5 KG/IN (CD) or more or less, per ASTM D5034-95. The cover layer may have a tear strength of about 2 LB/IN (MD) or more or less. The cover layer may have an elongation of about 40% (MD) or more or less, 60% (CD) or more or less, per ASTM 5034-95. The cover layer may have a film adhesion of 180 G or more or less. The bonding pattern of the film to the nonwoven may be any pattern, including diamond shaped.

The cover layers may be connected together and surround the heating layer and the insulating layer. The heating layer and/or the insulating layer may be connected to the one or more cover layers, to each other, or both. The cover layers may form an envelope, pocket, pouch, and/or bag structure within which the heating layer and or the cover layer are located.

In some instances, the cover (i.e., top layer and/or bottom layer) may be separated from the rest of the heating blanket. This may be advantageous to wash or sterilize the cover layer(s) or to replace one or both of the cover layers in the event they are damaged, without having to dispose of the entire blanket.

The heating blanket may include one or more insulation layers. An insulation layer may be located adjacent to the heating layer. An insulation layer may be located adjacent to the base or carrier layer of the heating layer. An insulation layer may have protective layer or material to restrict or prevent liquids (disinfectants, blood, etc.) from being absorbed.

An insulation layer may be made of a material comprising of polypropylene, low-density polymethylene (LDPE) polypropylene, fleece, non-woven fleece, polymeric foam or film, a thermally insulating material, a high-loft fibrous non-woven material, foam, compressible foam, or a combination thereof.

An insulating layer may function to retain heat generated by the heating layer. An insulating layer may function to protect a user or patient from electric shock hazards, burning due to excessive or elevated temperatures generated by the heating layer. An insulating layer may function to add comfort, softness, and/or weight to the heating blanket.

A heating blanket comprising a first heating segment comprising a first heating section and a first sensing section, each of the first heating section and first sensing section comprise a foil layer supported on a base layer, the foil layer in the first heating section comprises one or more heating elements and the foil layer in the first sensing section comprises one or more sensing elements, wherein the first heating section is folded over the first sensing section, or the first sensing section is folded over the first heating section such that the first sensing section overlays the first heating section. The one or more heating elements are one or more resistors that are integrally formed on the foil layer in the first heating section. The one or more heating elements are one or more resistors that are attached to the foil layer in the first heating section. The one or more sensing elements are temperature sensors that are integrally formed on the foil layer in the first sensing section. The one or more sensing elements are temperature sensors that are attached to the foil layer in the first sensing section. Prior to folding, the first heating section and the second heating section are arranged in a common plane. The heating blanket comprises a second heating segment comprising a second heating section and a second sensing section, wherein the second sensing section overlays the second heating section. The second heating section is folded over the second sensing section, or the second sensing section is folded over the second heating section. The second heating section is folded over the second sensing section at a second divider or the second sensing section is folded over the second heating section at the second divider, the first heating section is folded over the first sensing section at a first divider or the first sensing section is folded over the first heating section at the first divider, and the first divider is connected to the second divider to couple together the first heating segment and the second heating segment. The first divider and the second divider are arranged along a longitudinal axis of the heating blanket.

The first divider and/or the second divider is electrically conductive. The heating blanket comprises a third heating segment comprising a third heating section and a third sensing section, the third heating segment is coupled to the first heating segment. The heating blanket comprises a fourth heating segment comprising a fourth heating section and a fourth sensing section, the fourth heating segment is coupled to the second heating segment and to the third heating segment. The third heating section is folded over the third sensing section at a third divider or the third sensing section is folded over the third heating section at the third divider, the fourth heating section is folded over the fourth sensing section at a fourth divider or the fourth sensing section is folded over the fourth heating section at fourth third divider, and the third divider is connected to the fourth divider to couple together the third heating segment and the fourth heating segment. The third heating section is juxtaposed to the fourth sensing section, and the fourth heating section is juxtaposed to the third sensing section.

A heating blanket comprising: a first heating segment comprising a first heating section and a first sensing section, the first heating section comprises one or more heating elements and the first sensing section comprises one or more sensing elements, a second heating segment comprising a second heating section and a second sensing section, the second heating section comprises one or more heating elements and the second sensing section comprises one or more sensing elements, the first heating segment and the second heating segment are connected together such that the first heating section of the first heating segment is juxtaposed to the second sensing section of the second heating segment, and the second heating section of the second heating segment is juxtaposed to the first sensing section of the first heating segment. The first heating section and the first sensing section are arranged in a common plane. The second heating section and the second sensing section are arranged in a common plane. The first heating segment comprises a foil layer supported on a base layer, and the one or more heating elements are integrally formed on the foil layer. The first heating segment comprises a foil layer supported on a base layer, and the one or more heating elements are connected to the foil layer. The first sensing segment comprises a foil layer supported on a base layer, and the one or more sensing elements are integrally formed on the foil layer. The first sensing segment comprises a foil layer supported on a base layer, and the one or more sensing elements are connected to the foil layer.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patient applications and publications, are incorporated by reference for all purposes. Other combinations are also possible as will be gleaned from the following claims, which are also hereby incorporated by reference into this written description.

1) A heating blanket comprising:
a first heating segment comprising a first heating section and a first sensing section, the first heating section comprises one or more heating elements and the first sensing section comprises one or more sensing elements,
a second heating segment comprising a second heating section, the second heating section comprises one or more heating elements,
wherein the first sensing section overlaps the second heating section and the one or more sensing elements in the first sensing section monitor or determine an amount of heat generated by the one or more heating elements in the second heating section.

2) The heating blanket according to claim 1, wherein the second heating segment comprises a second sensing section, the second sensing section overlaps the first heating section and one or more sensing elements in the second sensing section monitor or determine heat generated by the one or more heating elements in the first heating section.

3) The heating blanket according to claim 1, wherein the first sensing section extends from a long edge of the first heating segment.

4) The heating blanket according to claim 1, wherein the second sensing section extends from a long edge of the second heating segment.

5) The heating blanket according to claim 1, wherein the first sensing section comprises one or more first fingers that project or cantilever from an edge of the first heating segment, the one or more first fingers overlap the second heating section.

6) The heating blanket according to claim 1, wherein the second sensing section comprises one or more second fingers that project or cantilever from an edge of the second heating segment, the one or more second fingers overlap the first heating section.

7) The heating blanket according to claim 1, wherein the first sensing section overlaps a top surface of the second heating section, and the second sensing section overlaps a top surface of the second heating section such that the first sensing section and the second sensing section are in a common plane.

8) The heating blanket according to claim 1, wherein the first sensing section overlaps a top surface of the second heating section, and the second sensing section overlaps a bottom surface of the second heating section such that the first sensing section and the second sensing section are in different planes.

9) The heating blanket according to claim 1, wherein the first heating segment comprises a heating layer comprising an electrically conductive foil layer disposed on an electrically insulative base layer.

10) The heating blanket according to claim 9, wherein the heating layer comprises one or more elongated slits that extend through a thickness of the heating layer.

11) The heating blanket according to claim 9, wherein the heating layer comprises a laminate covering the foil layer and the base layer.

12) The heating blanket according to claim 1, wherein the heating blanket comprises a top cover layer and a bottom cover layer, and the heating layer is disposed between the top cover layer and the bottom cover layer.

13) The heating blanket according to claim 1, wherein the heating blanket comprises a first attachment region that joins together the top cover layer and the bottom cover layer, the first attachment region is disposed laterally beyond one or more edges of the heating layer.

14) The heating blanket according to claim 1, wherein the heating blanket comprises a second attachment region that joins together the top cover layer and the bottom cover layer, the second attachment region is disposed laterally beyond the first attachment region.

15) A method of making the heating blanket according to claim 1, wherein the first heating segment comprises a heating layer comprising an electrically conductive foil layer disposed on an electrically insulative base layer, wherein the method comprises performing a material removal operation to remove portion of the electrically conductive foil, and portions of the electrically conducive foil that remain on the base layer are the one or more heating elements and/or the one or more sensing elements.
